(19) United States
(12) Patent Application Publication
(10) Pub. No.: US 2025/0102813 A1
(43) Pub. Date: Mar. 27, 2025

(54) MINIMIZING FORMATION OF CREASES DURING IPD ADJUSTMENTS FOR AN ARTIFICIAL REALITY HEADSET, AND STRUCTURES ASSOCIATED THEREWITH

(71) Applicant: Meta Platforms Technologies, LLC, Menlo Park, CA (US)

(72) Inventors: Taryn Monteleone, Seattle, WA (US); David Michael Pickett, Seattle, WA (US); Joel Bernard Jacobs, Seattle, WA (US); Jeffrey Taylor Stellman, Seattle, WA (US); Joseph Patrick Sullivan, Seattle, WA (US); Spencer Eggert, Sammamish, WA (US); Brett Delainey Christie, Seattle, WA (US); Celia Leach Doud, Seattle, WA (US)

(21) Appl. No.: 18/752,589

(22) Filed: Jun. 24, 2024

Related U.S. Application Data
(60) Provisional application No. 63/585,567, filed on Sep. 26, 2023.

(51) Int. Cl. G02B 27/01

(52) U.S. Cl. CPC G02B 27/0176; G02B 27/0179; G02B 2027/0154; G02B 2027/0181

(57) ABSTRACT

An artificial-reality headset comprises a first lens assembly coupled with a first shape guide, and a second lens assembly coupled with a second shape guide. The artificial-reality headset comprises an interpupillary-distance (IPD) adjustment system that moves one or both of the first lens assembly and the second lens assembly to produce a first IPD between the first lens assembly and the second lens assembly, and a second IPD between the first lens assembly and the second lens assembly. A membrane is included, and the membrane is in contact with the first and second shape guides such that: when the first IPD is produced between the first lens assembly and the second lens assembly, a number of creases in the portions of the membrane is a first number, and when the second IPD is produced between the first lens assembly and the second lens assembly, no new creases are introduced.

### RELATED APPLICATION(S)

This application claims priority to U.S. Provisional Application Ser. No. 63/585,567, filed Sep. 26, 2023, entitled “Minimizing Formation of Creases During IPD Adjustments for An Artificial Reality Headset, And Structures Associated Therewith,” which is hereby incorporated herein by reference in its entirety.

### TECHNICAL FIELD

This relates generally to an artificial-reality headset with an interpupillary-distance adjustment system that is covered by a polymer-based membrane, and the polymer-based membrane is configured to move along with the interpupillary-distance adjustment mechanism. The artificial-reality headset also includes a shape guide configured to maintain a surface of the polymer-based membrane, such that no new creases are introduced.

### BACKGROUND

Traditional artificial-reality headsets have adjustable interpupillary-distance adjustment mechanisms that include cosmetic covers that attempt to cover some of the interpupillary-distance adjustment mechanism. These traditional cosmetic covers have drawbacks, however, such as, covering the lenses when adjusted for narrow or wide interpupillary distances, material sagging, or the requirement of using less than desirable materials (e.g., material prone to quick wear or dirty easily). In some instances the traditional materials chosen can inhibit other features from being added to the artificial-reality headset.

As such, there is a need to address one or more of the above-identified challenges. A brief summary of solutions to the issues noted above are described below.

### SUMMARY

The methods, systems, and devices described herein provide a polymer-based membrane that covers an interpupillary-distance adjustment mechanism without the drawbacks described above. For example, the polymer-based membrane allows for easy cleaning, does not block lens assemblies when adjusted at the minimum and maximum IPDs, and does not cause further material sagging when adjusted at the minimum and maximum IPDs.

To achieve the partial list of benefits described above, an example artificial-reality headset is described. The example artificial-reality headset comprises a first lens assembly coupled with a first shape guide, and a second lens assembly coupled with a second shape guide. The artificial-reality headset also comprises an interpupillary-distance adjustment system that is configured to move one or both of the first lens assembly and the second lens assembly to produce (i) a first interpupillary distance between the first lens assembly and the second lens assembly and (ii) a second interpupillary distance between the first lens assembly and the second lens assembly. A polymer-based membrane is also included in this example, and the polymer-based membrane has a first opening associated with the first lens assembly, a second opening, distinct from the first opening, associated with the second lens assembly, and portions of the polymer-based membrane surrounding the first opening and the second opening. The polymer-based membrane, in this example, is also in contact with the first shape guide and the second shape guide such that: when the first interpupillary distance is produced between the first lens assembly and the second lens assembly, a number of creases in the portions of the polymer-based membrane surrounding the first opening and the second opening is a first number, and when the second interpupillary distance is produced between the first lens assembly and the second lens assembly, no new creases are introduced in the portions of the polymer-based membrane surrounding the first opening and the second opening, such that the number of creases is maintained at the first number.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an example artificial-reality headset with shape guides to control movement of a membrane that is configured to cover an interpupillary-distance adjustment system, in accordance with some embodiments.

FIG. 2 illustrates an example structure of a membrane, in accordance with some embodiments.

FIG. 3 illustrates example configurations of a membrane when the interpupillary-distance adjustment system is in various configurations, in accordance with some embodiments.

FIG. 4 illustrates an example mounting configuration of a shape guide to a lens assembly to control forces transmitted from a membrane to the lens assembly, in accordance with some embodiments.

FIG. 5 illustrates how thickness of the flexible portion of a membrane can be adjusted at certain locations to aid in forming the membrane, in accordance with some embodiments.

FIGS. 6A 6B, 6C-1, 6C-2, 6D-1, and 6D-2 illustrate example artificial-reality systems, in accordance with some embodiments.

FIGS. 7A-7B illustrate an example wrist-wearable device, in accordance with some embodiments.

FIGS. 8A, 8B-1, 8B-2, and 8C illustrate example head-wearable devices, in accordance with some embodiments.

FIGS. 9A-9B illustrate an example handheld intermediary processing device, in accordance with some embodiments.

FIG. 10 illustrates an example method flow chart for producing an artificial-reality headset, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

As described above, having an immersive artificial-reality experience requires that the artificial reality be displayed clearly and comfortably. Having an artificial-reality headset that includes a mechanism for adjusting IPD is useful for maintaining image clarity. However, in adjusting IPD comfort needs to be maintained, and thus it is important to ensure that happens despite lenses being moved when IPD is adjusted. Below are details on how a membrane that covers an adjustment mechanism can be controlled between IPD adjustments to maintain comfort.

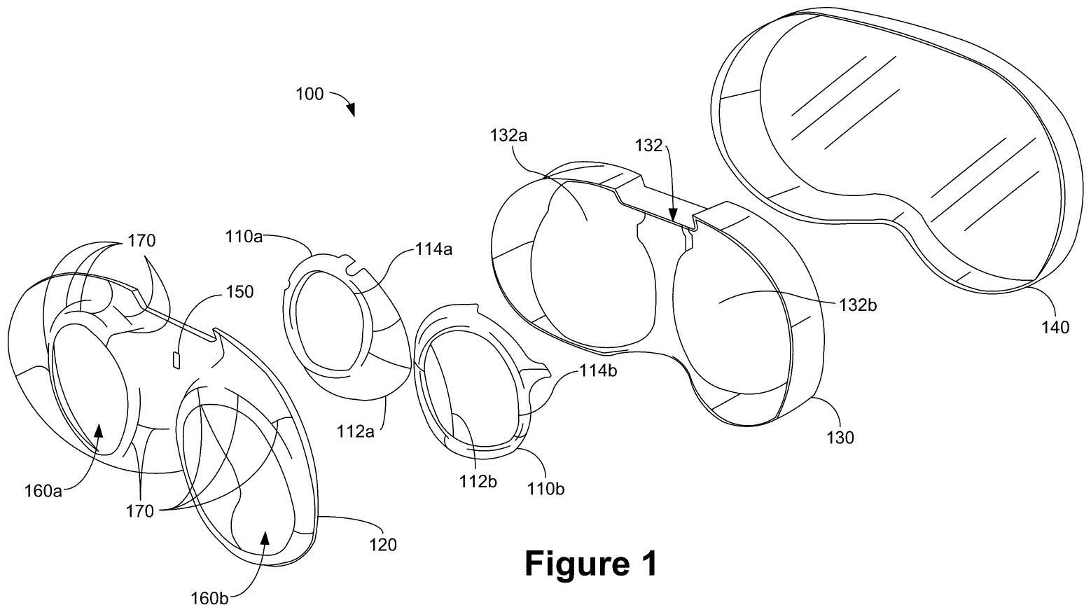

FIG. 1 illustrates some components of an example artificial-reality headset 100 (e.g., a virtual-reality headset) with shape guides 110a and 110b (also referred to interchangeably as a lens skirt) to control movement of a membrane 120 (also referred to interchangeably as a polymer-based membrane), and the membrane is configured to at least cover an interpupillary-distance adjustment system, in accordance with some embodiments. The membrane is also configured to cover some lens holding components of the one or more lens assemblies and/or internals of the artificial-reality headset 100.

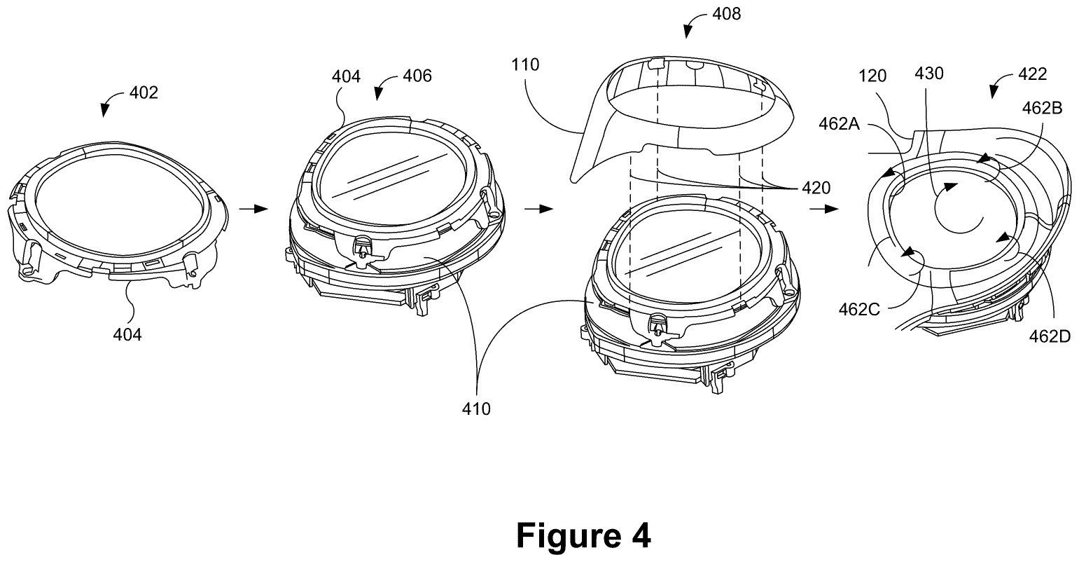

In some embodiments, the artificial-reality headset 100 includes a frame 130 and a housing 140 (e.g., the remaining portion of the artificial-reality headset, which can include electronics, displays, and other components). The frame 130 is configured such that it can be positioned within the housing 140 and coupled/integrated with the housing 140. The shape guides 110a and 110b can be positioned within the frame 130 and/or the housing 140. In some embodiments, the cutouts 132a and 132b in frame 130 are oversized such that shape guides 110a and 110b can move at least laterally, as a result of an interpupillary-distance adjustment system (not pictured), within the cutouts 132a and 132b. In some embodiments, the interpupillary-distance adjustment system is coupled/integrated into frame 130 and/or the housing 140. The membrane 120 can be positioned within the frame 130 and/or the housing 140, and is configured to move with shape guides 110a and 110b, and by extension one or more lens assemblies (described in detail in FIG. 4) coupled with the shape guides. Stated a different way, the membrane 120 is made of a high elasticity material that can change in shape based on movement of the shape guides 110a and 110b relative to the frame 130 and/or the housing 140.

The membrane 120 is coupled to the frame 130 at a frame lip 132 of the frame 130 and is coupled to respective lip portions 114a and 114b of the shape guides 110a and 110b. In some embodiments, the membrane 120 can be coupled with the housing 140. Coupling the membrane 120 to the frame 130 can be advantageous to reduce or prevent creasing (also referred to interchangeably as wrinkling) of the membrane 120. For example, the frame 130 can provide structure and/or support to the membrane 120 to reduce movement that can result in creasing of the membrane 120. Coupling the membrane 120 to the frame 130 can be advantageous to seal the artificial-reality headset 100 and to reduce or prevent environmental contaminants (e.g., liquid and/or dust) from entering the artificial-reality headset 100.

Membrane 120 includes a first opening 160a associated with a first lens assembly (described in reference to FIG. 4) and a second opening 160b associated with a second lens assembly (described in reference to FIG. 4). The openings 160a and 160b are configured to allow a user to see images displayed on the lens assemblies. The membrane 120 surrounds the openings 160a and 160b. The membrane can completely surround the openings 160a and 160b, such that while the membrane is attached to the shape guides 110a and 110b and/or the lens assemblies, the membrane can seal the artificial-reality headset 100 and can reduce or prevent environmental contaminants (e.g., liquid and/or dust) from entering the artificial-reality headset 100.

By having a membrane 120 that works in conjunction with a shape guide, the number of creases 170 in the membrane 120 does not change (e.g., the number of creases 170 is maintained at a constant number) throughout an adjustment range of an interpupillary-distance (IPD) adjustment system. In some embodiments, the number of creases 170 in the membrane 120 surrounding the openings 160a and 160b is maintained. In some embodiments, the locations of the preexisting creases are predetermined, such that the membrane is configured to pool additional material in specific locations (e.g., around a nose region and at the edges of the membrane). In addition, the direction in which the creases follow (e.g., a deepening valley away from a face of a wearer) is also predetermined such that material does not start to move towards a wearer's face. Maintaining the number of creases 170 throughout the entire adjustment range of the IPD adjustment system for the artificial-reality headset 100 can increase the maximum possible IPD adjustment range of the IPD adjustment system because the seal can be maintained to reduce or prevent environmental contaminants and in a manner that is comfortable for a user. Another advantage of maintaining the number of creases 170 can be enabling a reduction in the amount of light that might make its way into the artificial-reality headset 100 and undermine immersive artificial-reality experiences.

For example, if the number of creases 170 cannot be maintained, the creases may interfere with a user when the artificial-reality headset 100 is donned. In another example, if the number of creases 170 cannot be maintained, the IPD adjustment range may need to be reduced such that the membrane 120 does not interfere with the user (e.g., reduced such that the number of creases 170 does not increase and/or decrease).

Additionally, the shape guide in conjunction with the membrane can also provide an ergonomic shape (of the membrane 120 described above) to ensure that a non-interference fit is provided and maintained for wearers of artificial-reality systems. Stated differently, since the number of creases 170 is maintained at the first number as the IPD adjustments are made, the membrane 120 can be said to maintain a smooth topography (e.g., does not buckle, wrinkle, ripple, etc.). Stated in a third way, the goal is to maintain an approximate contour shape throughout the entire IPD adjustment range of the IPD adjustment system. In some embodiments, the first number of creases is zero creases. While the primary example used in this disclosure relates to adjusting IPD and maintaining a consistent deformation and/or shape (also referred to interchangeably as a smooth topography) for the membrane 120 that covers the first and second lens assemblies, additional examples are also contemplated in which, e.g., the system can additionally or alternatively be configured to ensure that wrinkle-free adjustments to the membrane 120 occur when movements to the lens assemblies occur along two additional axes (e.g., a total of three axes movement of the lens assemblies).

In some embodiments, the membrane 120 is in contact with the shape guides 110a and 110b such that the membrane 120 and the shape guides 110a and 110b can move relative to each other. Stated another way, the membrane 120 is configured to slidably rest on top of the shape guides 110a and 110b. The movement can reduce or prevent wrinkling of the flexible portion of the membrane by controlling movement of the membrane 120. The shape guides 110a and 110b can support membrane 120 to maintain the shape of membrane 120. In some embodiments, the shape guides 110a and 110b include a first shape guide 110a and a second shape guide 110b, respectively.

The first shape guide 110a can include a first elongated portion 112a. The second shape guide 110b can include a second elongated portion 112b. The first elongated portions 112a and 112b are configured to extend around a portion of a perimeter (e.g., the portion that circumscribes the lens assembly, as described in further detail with reference to FIG. 4) of the shape guides 110a and 110b, respectively. The elongated portions 112a and 112b can be configured to maintain contact with the membrane 120.

In some embodiments, the first shape guide 110a is distinct from the second shape guide 110b. The first shape guide 110a and the second shape guide 110b can be mirror opposites of each other. In some embodiments, the first shape guide 110a and the second shape guide 110b can be pointed towards each other such that the distance between the first elongated portion 112a and the second elongated portion 112b are closer than a distance between a center of the opening of the first shape guide 110a and the second shape guide 110b. Stated another way, the first shape guide 110a and the second shape guide 110b face each other when the respective elongated portions 112a and 112b are facing each other (e.g., pointed towards each other). Stated a third way, the first shape guide 110a and the second shape guide 110b face each other when the combination of the first shape guide 110a and the second shape guide 110b form a nose-like shape (e.g., a shape that can receive a nose without interference).

As referenced, the IPD adjustment system can be configured to move one or both lens assemblies (e.g., a first lens assembly and a second lens assembly). The IPD adjustment system can be configured to produce various IPDs by moving the first lens assembly and the second lens assembly. The IPD can be measured from an optical center of the first lens assembly and the second lens assembly, respectively. In some embodiments, the IPD adjustment system, or other lens movement system, can move one or both lens assemblies vertically or alter the depth of the lens, in addition to horizontally (i.e., for adjusting IPD). For example, when the artificial-reality headset 100 is donned by a user, movement along the z-axis would move the one or more lens assemblies towards or away from the user (e.g., to help with focus for a user with impaired vision). In some embodiments, the IPD adjustment occurs via a manual control. In some other embodiments, the IPD adjustment occurs automatically through the use of sensors and actuators moving the lens assemblies in response to data (e.g., pupil location data) derived from the sensors. In some embodiments, the membrane 120 includes an infrared transparent region 150. The infrared transparent region 150 can be configured to allow infrared signals to pass through the membrane 120. The infrared transparent region can be an opening or a cut out where there is no material in that region of the membrane 120. The infrared transparent region can be a region of membrane 120 that is constructed from materials that are optically transparent to at least infrared signals.

In some embodiments, an infrared sensor can be positioned behind the infrared transparent region. The infrared sensor can be used to provide proximity information, such that a determination can be made as to whether a user has donned or doffed the artificial-reality headset 100. In some embodiments, the infrared sensor is positioned between the membrane 120 and the shape guides 110. In some embodiments, the infrared sensor can be coupled to the membrane 120 and/or the housing 140.

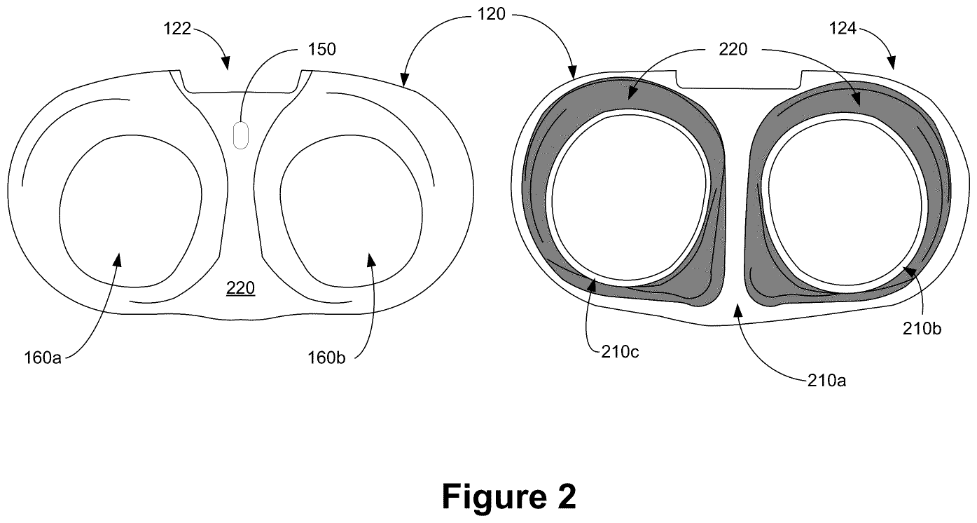

FIG. 2 illustrates front view and a back view of an example structure of a membrane 120, in accordance with some embodiments. FIG. 2 further illustrates the membrane 120 shown in FIG. 1, by showing a user-facing side 122 and a non-user-facing side 124. The membrane 120 can be formed from one or more polymers (e.g., silicone and/or plastic). A polymer-based membrane 120 can be advantageous because it can be easier to clean than more absorbent and porous materials such as cloth. Additionally, the polymer-based membrane 120 can be chemically inert, and thus less likely to deteriorate over time when exposed to various environmental contaminants (e.g., sweat from a wearer) and/or cleaning solutions. In some embodiments, however, portions of the membrane 120 can be constructed to form a fabric-like material.

The membrane 120 includes rigid portions 210a-210c, which are configured to provide structure and/or rigidity to the membrane 120. The rigid portions are further configured to attach to the frame 130 and the shape guides 110a and 110b. The rigid portions 210a-210c can include three separate rigid portions: a rigid frame portion 210a, a rigid first lens portion 210b, and a rigid second lens portion 210c. In some embodiments, the rigid portions 210a-210c can be formed from one or more polymers, one or more metals, one or more composites, one or more ceramics, and/or one or more materials with specified rigidity. In some embodiments, the rigid portions 210a-210c can be formed separately from a flexible portion 220 of membrane 120.

The membrane 120 includes the flexible portion 220, which fills the gaps between rigid portions 210a-210c. The flexible portion 220 can be continuous and/or a single piece. The flexible portion 220 can be coupled and/or molded (e.g., injection molded) to the rigid portions 210a-210c to form the membrane 120. The flexible portion 220 can be coupled and/or molded to the rigid frame portion 210a, the rigid first lens portion 210b, and the rigid second lens portion 210c to form the membrane 120.

In some embodiments, the rigid portions 210a-210c and/or the flexible portion 220 include infrared transparent region 150 (e.g., an opening or a cut out) to allow infrared signals to pass through. In some embodiments, the rigid portion 210a-210c and/or the flexible portion 220 include an infrared transparent region 150 to allow infrared signals to pass through. In some embodiments, the rigid portions 210a-210c are made from an infrared transparent material and the flexible portion 220 has an opening that when combined allow the infrared signals to pass through.

In some embodiments, the membrane 120 is formed via injection molding. The membrane 120 can be formed via multi-shot injection molding (e.g., two-shot injection molding or overmolding). The rigid portion 210a-210c can be formed via injection molding (e.g., a first shot of a two-shot injection molding process), and the flexible portion 220 can be injection molded (e.g., a second shot of a two-shot injection molding process) to the rigid portion 210a-210c. The flexible portion 220 can be injection molded to the rigid portion 210a-210c without post-processing (e.g., sanding or adhesives) of the rigid portion 210a-210c while maintaining a specified adhesion and/or coupling strength between the rigid portion 210a-210c and the flexible portion 220.

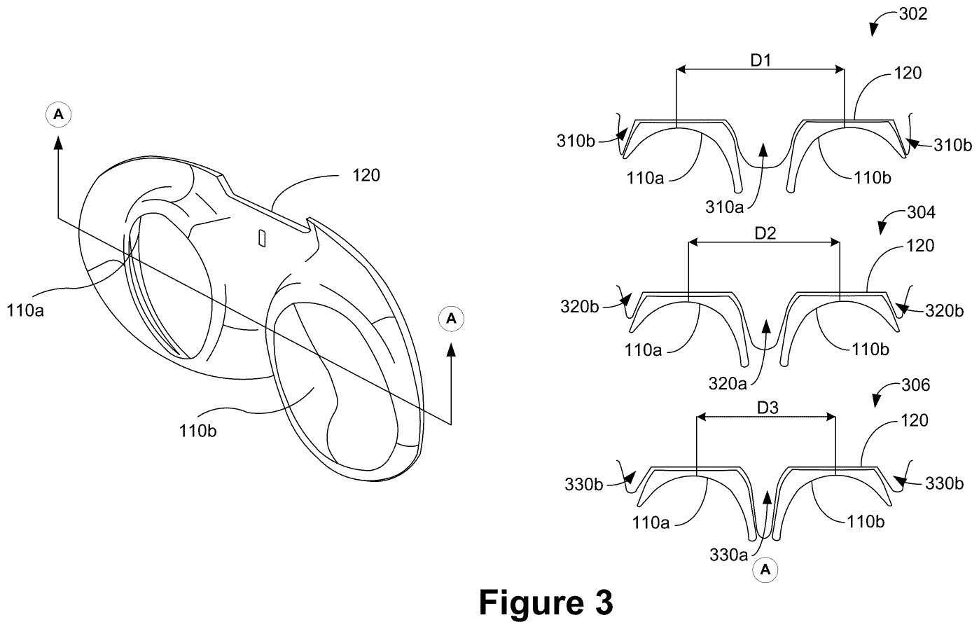

FIG. 3 illustrates example configurations of a membrane 120 when the IPD adjustment system is in various configurations, in accordance with some embodiments. FIG. 3 shows a membrane 120 that is coupled to shape guides 110a and 110b, and three cutaway views 302, 304, and 306, each of which illustrates how the adjustment of the IPD interacts with the membrane 120. The IPD adjustment system can move the first and the second lens assembly to at least positions corresponding to an IPD of D1-D3. For at least some positions of the lens assemblies, the shape guides 110a and 110b can assist in forming and/or maintaining one or more creases 310a-310b, 320a-320b, and 330a-330b. The shape of the creases 310a-310b, 320a-320b, and 330a-330b can change based on IPDs D1-D3. The shape of the creases 310a-310b, 320a-320b, and 330a-330b can be configured to reduce or prevent an additional crease from forming at the creases 310a-310b, 320a-320b, and 330a-330b. The creases 310a-310b, 320a-320b, and 330a-330b can be an area where excess membrane 120 material can be stored and/or retrieved (e.g., excess material pools in predefined creases) from to maintain the same number of creases throughout the IPD adjustment range of the IPD adjustment system (e.g., D1-D3). For example, when the number of creases at a specified IPD is zero creases, then zero creases are maintained when the IPD adjustment system is adjusted such that the IPD increases (e.g., the lens assemblies are further apart), and when the IPD adjustment system is adjusted such that the IPD decreases (e.g., the lens assemblies are closer together). In some embodiments, the creases 310a-310b, 320a-320b, and 330a-330b help maintain a smooth topography, by being positioned such that no new creases are introduced when the IPD is adjusted. The creases may reduce wrinkling of the flexible portion of the membrane 120 by providing a space for the excess flexible material to be stored when the IPD is adjusted. The creases 310a-310b, 320a-320b, and 330a-330b may reduce wrinkling of the flexible portion of the membrane by providing addition stored flexible material when the interpupillary distance is adjusted. In some embodiments, the creases 310a-310b, 320a-320b, and 330a-330b control the location where the flexible portion of the membrane bends. In some embodiments, the depth of the creases changes as the IPD is adjusted.

In another example, at the first IPD D1, the first creases 310a-310b are in a first shape, at the second IPD D2, the second creases 320a-320b are in a second shape, and at the third IPD D3, the third creases 330a-330b are in a third shape. As shown, the first IPD D1 is greater than second IPD D2, which is greater than third IPD D3. The center creases 310a, 320a, 330a and the edge creases 310b, 320b, and 330b can change in shape without forming additional creases as the IPD is adjusted from the first IPD D1 to the second IPD D2 to the third IPD D3.

For example, as the IPD decreases, as shown in cutaway view 306, the membrane 120 at the center crease (as shown by center crease 330a) can be compressed into a smaller area between the shape guides 110a and 110b. In this example, the depth of the center crease can increase as the membrane 120 is compressed between the shape guides 110a and 110b. The membrane 120 is guided by (e.g., constrained by) the first shape guide 110a and the second shape guide 110b, as the shape guides 110a and 110b are brought closer together as the IPD decreases. As the IPD decreases, the membrane 120 at the edge creases (as shown by edge creases 330b) can be expanded into a greater area between the shape guides 110a, 110b and the frame 130. In this example, the depth of edge creases decreases as the membrane 120 expands to fill the area between the shape guides 110a and 110b and the frame 130. Thus, the membrane 120 is guided by (e.g., constrained by) the first shape guide 110a and the second shape guide 110b as the shape guides are moved away from the frame 130 as the IPD decreases.

For example, as the IPD increases, as shown in cutaway view 302, the membrane 120 at the center crease (as shown by center crease 310a) can be expanded into a larger area between the shape guides 110a, 110b. In this example, the depth of the center creases can decrease as the membrane 120 is expanded between the shape guides 110a and 110b. The membrane 120 is guided by (e.g., constrained by) the first shape guide 110a and the second shape guide 110b as the shape guides 110a, 110b are moved further apart as the IPD increases. As the IPD increases, the membrane 120 at the edge creases (as shown by edge creases 310b) can be compressed into a smaller area between the shape guides 110a and 110b and the frame 130. In this example, the depth of edge creases increases as the membrane 120 compresses between the shape guides 110a and 110b and the frame 130. The membrane 120 is guided by (e.g., constrained by) the first shape guide 110a and the second shape guide 110b as the shape guides are moved closer to the frame 130 as the IPD increases.

Cutaway view 304 further illustrates an intermediary IPD adjustment that occurs between the IPD adjustments shown in cutaway view 302 and 306. While only three adjustments are shown, other steps of adjustments are conceivable (e.g., stepless adjustments, 5-step adjustments, 10-step adjustments, 20-step adjustments, etc.).

FIG. 4 illustrates an example mounting configuration of a shape guide 110 to a lens assembly 410 to control forces 420 transmitted from a membrane to the lens assembly, in accordance with some embodiments.

FIG. 4 shows four steps of how a lens assembly is mounted to membrane, which are discussed in order below. First, step 402 shows a mounting bracket 404 being provided, and the mounting bracket is configured to be coupled with a lens assembly 410 and a shape guide 110.

Second step 406 shows mounting bracket 404 being coupled with the lens assembly 410, which can, in this example, is configured to be coupled via fasteners. These fastener locations can be selected in order to control the locations in which force is applied to the lens assembly.

Third step 408 shows shape guide 110 (i.e., corresponding to the shape guide 110b shown in FIGS. 1 and 3) being mounted to the mounting bracket and subsequently to the lens assembly 410. As shown, the shape guide 110 is separate (e.g., a discrete component) from the lens assembly 410. However, in some embodiments, the shape guide 110 and the mounting bracket 404 can be integrated into a lens assembly 410 (i.e., such that the lens assembly is configured to attach to a membrane 412 directly without an intermediary component). As shown, the shape guide 110 is configured to attach to the mounting bracket 404 via clips located at predetermined mounting locations 420. In some embodiments, the shape guide 110 is coupled via fasteners, adhesives, or a combination of two or more of fasteners, adhesives, and clips. As shown, the shape guide 110 can circumscribe the lens assembly 410.

Fourth step 422 illustrates how the torque 430 is generated by the membrane (e.g., the torque 430 originates from the stretching or compression of the membrane 120) and how it is counteracted by the torque 426A-426D exerted at the predetermined mounting locations 420. Having a net torque value of zero or near zero applied to the lens assembly is important for ensuring that images displayed at the lens assembly are not distorted. The torque 430 and torque 426A-426D are shown for illustrative purposes and may not reflect the exact positions in which the torque is applied. Thus, the predetermined mounting locations 420 are selected such that when the membrane 120 is affixed to the shape guide 110, the torque on the lens is balanced at all locations surrounding the shape guide. In other words, the torque at the specified mounting locations 420 counteract the torque from the membrane 120. In some embodiments, the mounting positions 420 can be chosen such that the torque 430 does not impact display of images, or the user experience, associated with the lens assembly 410 (e.g., a non-zero torque is transmitted to the lens assembly, but the torque does not impact the operation of the lens assembly 410, or the user experience associated with the lens assembly 410).

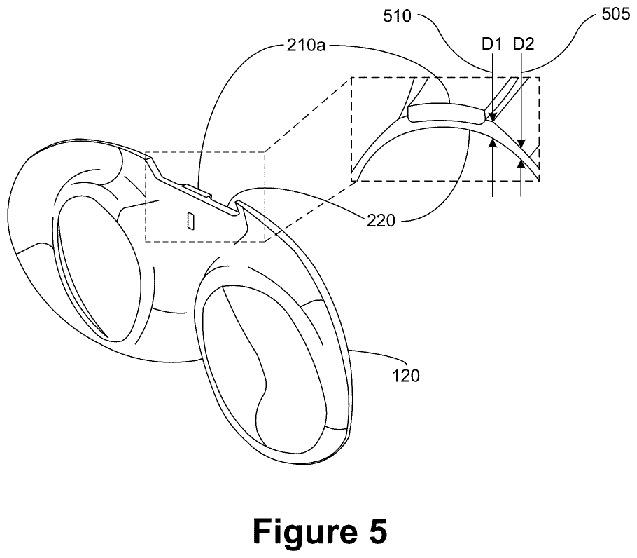

FIG. 5 illustrates how thickness of the flexible portion 220 of a membrane 120 can be adjusted at certain locations to aid in forming the membrane 120, in accordance with some embodiments. The thickness of the flexible portion 220 of the membrane 120 can be increased when the flexible portion 220 of the membrane 120 is molded to the rigid portion 210a of the membrane 120. For example, the flexible portion 220 of the membrane can range from 0.40 mm to 0.73 mm in thickness. The flexible portion 220 of the membrane 120 can be thinner to reduce a weight of the flexible portion 220 of the membrane 120, as shown by thickness 505. The flexible portion 220 of the membrane can be thicker at the interface (i.e., thicker than thickness 505) with the rigid portion 210a of the membrane 120 to increase the strength (e.g., by increasing the surface area of the contact) of the coupling between the rigid portion of the membrane 120 and the flexible portion of the membrane 120, as shown by thickness 510. The flexible portion 220 can be thicker at any interface with the rigid portion of the membrane 120 (e.g., is not limited to only increasing in thickness at the rigid portion 210a and can also increase in thickness at the rigid portions 210b).

(A1) In accordance with some embodiments, an artificial-reality headset (e.g., artificial-reality headset 100 and its components described in reference to FIGS. 1-5) comprises a first lens assembly (e.g., lens assembly 410 shown in FIG. 3) coupled with a first shape guide (e.g., first shape guide 110a in FIG. 1). In some embodiments, first shape guide (hereinafter also referred to as first lens skirt or a left lens skirt) can be an integrated component of the first lens assembly or can be a separate discrete component configured to be coupled with the first lens assembly. The artificial-reality headset also includes a second lens assembly (e.g., a second lens assembly akin to lens assembly 410 shown in FIG. 3) coupled with a second shape guide (e.g., second shape guide 110b in FIG. 1). In some embodiments, second shape guide (hereinafter also referred to as second lens skirt or a right lens skirt) can be an integrated component of the first lens assembly or can be a separate discrete component configured to be coupled with the first lens assembly. Stated another way, the first shape guide can be integrally formed with a carrier that holds one or more lenses together, and the second shape guide can be integrally formed with another carrier that holds one or more other lenses together. The artificial-reality headset further includes an interpupillary-distance adjustment system (e.g., an interpupillary-distance adjustment system that is integrated into frame 130 and/or the housing 140 of FIG. 1) that is configured to move one or both of the first lens assembly and the second lens assembly to produce (i) a first interpupillary distance (IPD) between the first lens assembly and the second lens assembly and (ii) a second interpupillary distance between the first lens assembly and the second lens assembly (e.g., FIG. 3 illustrates how different IPD adjustments can be selected). In some embodiments, IPD is measured from the optical center of the lens. The artificial-reality headset also includes a polymer-based membrane having (e.g., rubber, vinyl, fabric, or silicone, all of which can be advantageous due to their respective ability to be easily cleaned by the end-user) a first opening associated with the first lens assembly, a second opening, distinct from the first opening, associated with the second lens assembly, and portions of the polymer-based membrane surrounding the first opening and the second opening (e.g., FIGS. 1-5 each illustrate a membrane 120, and FIG. 1 illustrates that membrane 120 includes a first opening 160a associated with a first lens assembly and a second opening 160b associated with a second lens assembly). In some embodiments, the polymer-based membrane seals or substantially seals (e.g., 90% sealed) the interpupillary-distance adjustment system from environmental contaminants, including liquid (e.g., moisture from sweat) and dust. The polymer-based membrane is in contact with the first shape guide and the second shape guide such that: when the first interpupillary distance is produced between the first lens assembly and the second lens assembly, a number of creases in the portions of the polymer-based membrane surrounding the first opening and the second opening is a first number, and when the second interpupillary distance is produced between the first lens assembly and the second lens assembly, no new creases are introduced in the portions of the polymer-based membrane surrounding the first opening and the second opening, such that the number of creases is maintained at the first number. For example, FIG. 3 shows in cutaway views 302, 304, and 306 that no new creases are introduced despite the IPD being adjusted between D1, D2, and D3.

Additionally, the above provides an ergonomic shape (of the polymer-based material described above) to ensure that a non-interference fit is provided and maintained for wearers of artificial-reality systems. Stated differently, since the number of creases is maintained at the first number as the IPD adjustments are made, the polymer-based material can be said to maintain a smooth topography (e.g., does not buckle, wrinkle, ripple, etc.). In some embodiments, a goal of the shape guide along with the is to maintain an approximate contour shape throughout the entire IPD adjustment range. In some embodiments, the first number of creases is zero creases. The features described above enable a broader range of IPD adjustment for the overall artificial-reality headsets, and also enables a reduction in amount of light that might make its way into the system and undermine immersive AR experiences.

In some embodiments, the artificial-reality headset can additionally or alternatively be configured to ensure that wrinkle-free adjustments to the polymer-based membrane occur along multiple axes (e.g., additionally along the x-axis (e.g., adjustment of horizontal IPD adjustment)), y-axis (e.g., adjustment of vertical IPD adjustment), and z-axis (e.g., adjustment of depth of lens assembly relative to a wearer's eye).

(A2) In some embodiments of A1, the first interpupillary distance is greater than the second interpupillary distance, and the interpupillary-distance adjustment system is configured to move one or both of the first lens assembly and the second lens assembly to produce a third interpupillary distance between the first lens assembly and the second lens assembly, wherein the third interpupillary distance is less than the first interpupillary distance and greater than the second interpupillary distance. In some embodiments, when the third interpupillary distance is produced between the first lens assembly and the second lens assembly, no new creases are introduced in the portions of the polymer-based membrane surrounding the first opening and the second opening, such that the number of creases is maintained at the first number. For example, FIG. 3 shows three different IPDs ranging from D1-D3.

(A3) In some embodiments of any of A1-A2, the first shape guide includes a first elongated portion to maintain contact with the polymer-based membrane and to maintain the first number of creases in the portions of the polymer-based membrane when the first interpupillary distance or the second interpupillary distance is produced. For example, FIG. 1 shows a first elongated portion 112a and a second elongated portion 112b that are configured to contact the membrane 120. In some embodiments, the first elongated portion does not extend around a full perimeter of the first shape guide. In some embodiments, the second shape guide includes a second elongated portion to maintain contact with the polymer-based membrane and to maintain the first number of creases in the portions of the polymer-based membrane when the first interpupillary distance or the second interpupillary distance is produced, wherein the second elongated portion does not extend around a full perimeter of the second shape guide, and wherein the first elongated portion faces the second elongated portion (e.g., the first elongated portion is configured to be placed near a first side of a user's nose, and the second elongated portion is configured to be placed near a second side of a user's nose).

(A4) In some embodiments of any of A1-A3, the first shape guide circumscribes the first lens assembly to couple with the first lens assembly and defines the first opening, and the second shape guide circumscribes the second lens assembly to couple with the second lens assembly and defines the second opening. For example, FIG. 4 shows that the shape guide 110 circumscribes the lens assembly 410.

(A5) In some embodiments of any of A1-A4, the polymer-based membrane is configured to slidably rest on top of first shape guide and the second shape guide to allow movement of one or more predefined creases such that no new creases are introduced. For example, FIG. 3 shows the membrane 120 slidably resting on shape guides 110a and 110b to allow for movement. In some embodiments, the shape guide is not molded to the flexible portion of the membrane. The shape guide not molded to the flexible portion of the membrane allows the flexible portion to move relative to the shape guide. The movement may reduce or prevent wrinkling of the flexible portion of the membrane. In some embodiments, the shape guide may assist in forming/maintaining one or more creases.

(A6) In some embodiments of any of A1-A5, the polymer-based membrane includes predefined creases that have respective depths that are configured to change when a distance between the first lens assembly and the second lens assembly is adjusted via the interpupillary-distance adjustment system, such that no new creases are introduced. In some embodiments, the creases are at predefined locations on the polymer-based membrane to help maintain a smooth topography or control where buckling of the membrane takes place. In some embodiments, the creases can reduce wrinkling of the polymer-based membrane by providing a space for the excess flexible material to be stored when the interpupillary distance is adjusted. For example, FIG. 3 shows that no new creases are introduced when IPD adjustments are made.

(A7) In some embodiments of any of A1-A6, the polymer-based membrane spans a length of the artificial-reality headset and the polymer-based membrane varies in thickness across the length of the artificial-reality headset, wherein respective variations in thickness are selected such that no new creases are introduced when a distance between the first lens assembly and the second lens assembly is adjusted via the interpupillary-distance adjustment system. For example, FIG. 5 shows that thickness 510 is greater than thickness 505, such that thickness 510 is thicker at the junction between rigid portion 210a and flexible portion 220.

(A8) In some embodiments of A7, the respective variations in thickness are positioned where a flexible portion of the polymer-based membrane is molded to a portion of the artificial-reality headset. In some embodiments, polymer-based membrane ranges from 0.2 mm to 1.5 mm in thickness (e.g., 0.40 mm to 0.73 mm in thickness). The flexible portion of the membrane is thicker where it connects with the headset frame. For example, FIG. 5 shows that thickness 510 is greater than thickness 505, such that thickness 510 is thicker at the junction between rigid portion 210a and flexible portion 220.

(A9) In some embodiments of any of A1-A8, the first shape guide is coupled to the first lens assembly at locations around the first lens assembly, the location selected such that forces (and resulting torque) transmitted from the polymer-based membrane to the first lens assembly are controlled to remove artifacts caused by a misalignment of one or more lenses within the first lens assembly. In some embodiments, the second shape guide is coupled to the second lens assembly at locations around the first lens assembly, the location selected such that forces (and resulting torque) transmitted from the polymer-based membrane to the second lens assembly are controlled to remove artifacts caused by a misalignment of one or more lenses within the second lens assembly. In some embodiments, the forces and resulting torque originate from the stretching or compression of the flexible portion of the membrane, and the mounting locations are selected to counteract the torque from the polymer-based membrane. In other words, the mounting locations are chosen such that there is an equal distribution of force along the perimeter of the lens assembly. For example, FIG. 4 shows how the shape guide 110 is coupled to the lens assembly 410 such that the torque applied by the membrane 120 is counteracted, such that there is no misalignment of the lenses.

(A10) In some embodiments of any of A1-A9, the polymer-based membrane is molded with (integrally formed with) one or more rigid structures (e.g., the rigid structures are constructed with a metal, an alloy, a composite, or a rigid polymer), and the rigid structures are configured to couple with (i) the first lens assembly, (ii) the second lens assembly, and (iii) a stationary portion of the artificial-reality headset to produce an interpupillary-distance adjustment system cover. In some embodiments, the stationary portion encompasses the first lens assembly and the second lens assembly. In some embodiments, the polymer-based membrane is molded to the rigid portion in a two-part injection molding process. In some embodiments, the polymer-based membrane is molded to the rigid portion without the use of adhesives. In some embodiments, the polymer-based membrane is molded to the rigid portion without the use of secondary processes on the rigid portion prior to the polymer-based membrane being molded to the rigid portion. For example, FIG. 4 shows the different components that make up the artificial-reality headset.

(A11) In some embodiments of any of A1-A10, the polymer-based membrane is molded with one or more rigid structures via a two-shot injection molding process, and the first shot forms the one or more rigid structures and the second shot molds the polymer-based membrane to the one or more rigid structures. For example, FIG. 5 shows a rigid portion 210a and a flexible portion 220.

(A12) In some embodiments of any of A1-A11, the artificial-reality headset of claim 1, wherein no surface treatment is needed on the one or more rigid structured to secure the polymer-based membrane to the one or more rigid structures.

(A13) In some embodiments of any of A1-A12, the one or more rigid structures are infrared transparent, such that an infrared sensor can receive one or more infrared signals. In some embodiments, an infrared (IR) sensor is positioned behind one of the one or more rigid structures. In some embodiments, the IR sensor is coupled to one of the one or more rigid structures. In some embodiments, the IR sensor provides proximity information, such that a determination can be made as to whether the headset is donned by the wearer. In some embodiments, the polymer-based membrane does not cover an IR sensor. In some embodiments, the polymer-based membrane does cover an IR sensor. For example, FIG. 2 shows that the membrane 120 includes an infrared transparent region 150, and the infrared transparent region 150 is configured to allow infrared signals to pass through the membrane 120.

(B1) In accordance with some embodiments, a shape guide comprises a coupling that is configured to secure the shape guide to a lens assembly, and the lens assembly is configured to be coupled to a interpupillary-distance adjustment system, wherein the interpupillary-distance adjustment system is configured to move the first lens assembly to produce (i) a first interpupillary distance between the first lens assembly and a second lens assembly and (ii) a second interpupillary distance between the first lens assembly and the second lens assembly. The shape guide includes another coupling that is configured to secure a polymer-based membrane around a first portion of the shape guide (e.g., perimeter of lens assembly). The shape guide also includes a second portion of the shape guide having an elongated (e.g., curved) surface configured to guide a portion of the polymer-based membrane, such that: when the first interpupillary distance is produced between the first lens assembly and the second lens assembly, a number of creases in the polymer-based membrane is a first number, wherein the first number is partially dictated by the shape guide, and when the second interpupillary distance is produced between the first lens assembly and the second lens assembly, no new creases are introduced in the polymer-based membrane, such that the number of creases is maintained at the first number.

(B2) In some embodiments, the artificial-reality headset is configured in accordance with any of claims A1-A13.

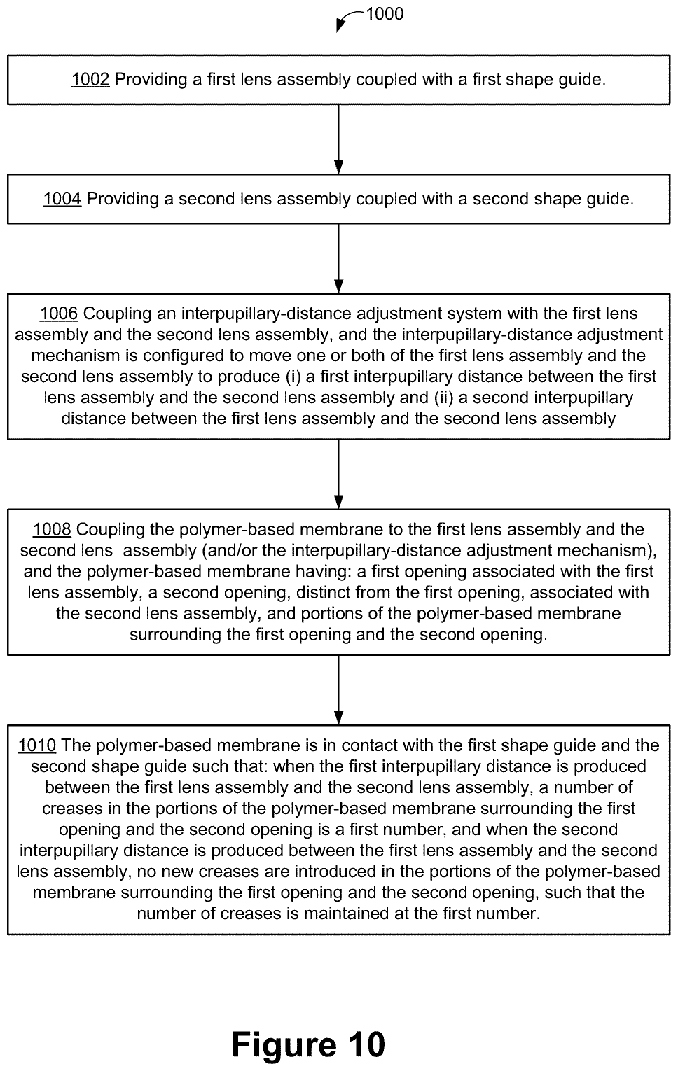

(C1) In accordance with some embodiments, a method of producing an artificial-reality headset comprises, providing (step 1002, as shown in FIG. 10) a first lens assembly coupled with a first shape guide; providing (1004) a second lens assembly coupled with a second shape guide. The method includes, coupling (1006) an interpupillary-distance adjustment system with the first lens assembly and the second lens assembly, and the interpupillary-distance adjustment mechanism is configured to move one or both of the first lens assembly and the second lens assembly to produce (i) a first interpupillary distance between the first lens assembly and the second lens assembly and (ii) a second interpupillary distance between the first lens assembly and the second lens assembly. The method also includes, coupling (1008) the polymer-based membrane to the first lens assembly and the second lens assembly (and/or the interpupillary-distance adjustment mechanism), and the polymer-based membrane having: a first opening associated with the first lens assembly, a second opening, distinct from the first opening, associated with the second lens assembly, and portions of the polymer-based membrane surrounding the first opening and the second opening. The polymer-based membrane is in contact (1010) with the first shape guide and the second shape guide such that: when the first interpupillary distance is produced between the first lens assembly and the second lens assembly, a number of creases in the portions of the polymer-based membrane surrounding the first opening and the second opening is a first number, and when the second interpupillary distance is produced between the first lens assembly and the second lens assembly, no new creases are introduced in the portions of the polymer-based membrane surrounding the first opening and the second opening, such that the number of creases is maintained at the first number.

(D2) In some embodiments of D1, the artificial-reality headset is configured in accordance with any of A1-A13.

(E1) In accordance with some embodiments, a polymer-based membrane comprises a first opening associated with a first lens assembly, wherein the first lens assembly is coupled with a first shape guide. The polymer-based membrane comprises a second opening, distinct from the first opening, associated with a second lens assembly, wherein the second lens assembly is coupled with a second shape guide and portions of the polymer-based membrane surrounding the first opening and the second opening. The polymer-based membrane is configured to be coupled with an interpupillary-distance adjustment system, and the interpupillary adjustment system is configured to move one or both of the first lens assembly and the second lens assembly to produce (i) a first interpupillary distance between the first lens assembly and the second lens assembly and (ii) a second interpupillary distance between the first lens assembly and the second lens assembly. The polymer-based membrane is in contact with the first shape guide and the second shape guide such that: when the first interpupillary distance is produced between the first lens assembly and the second lens assembly, a number of creases in the portions of the polymer-based membrane surrounding the first opening and the second opening is a first number, and when the second interpupillary distance is produced between the first lens assembly and the second lens assembly, no new creases are introduced in the portions of the polymer-based membrane surrounding the first opening and the second opening, such that the number of creases is maintained at the first number.

(E2) In some embodiments of E1, the polymer-based membrane is configured in accordance with any of A1-A13.

The devices described above are further detailed below, including systems, wrist-wearable devices, headset devices, and smart textile-based garments. Specific operations described above may occur as a result of specific hardware, and such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device 700, a head-wearable device, an HIPD 900, a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; and/or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO₂ sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) artificial-reality (AR) applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

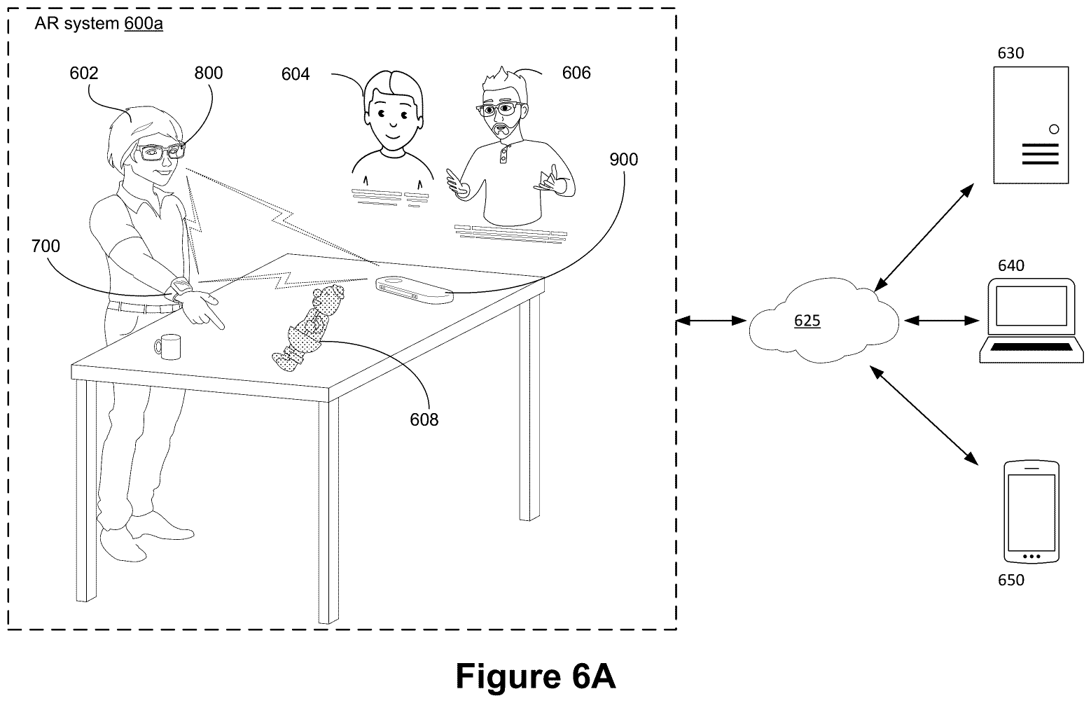

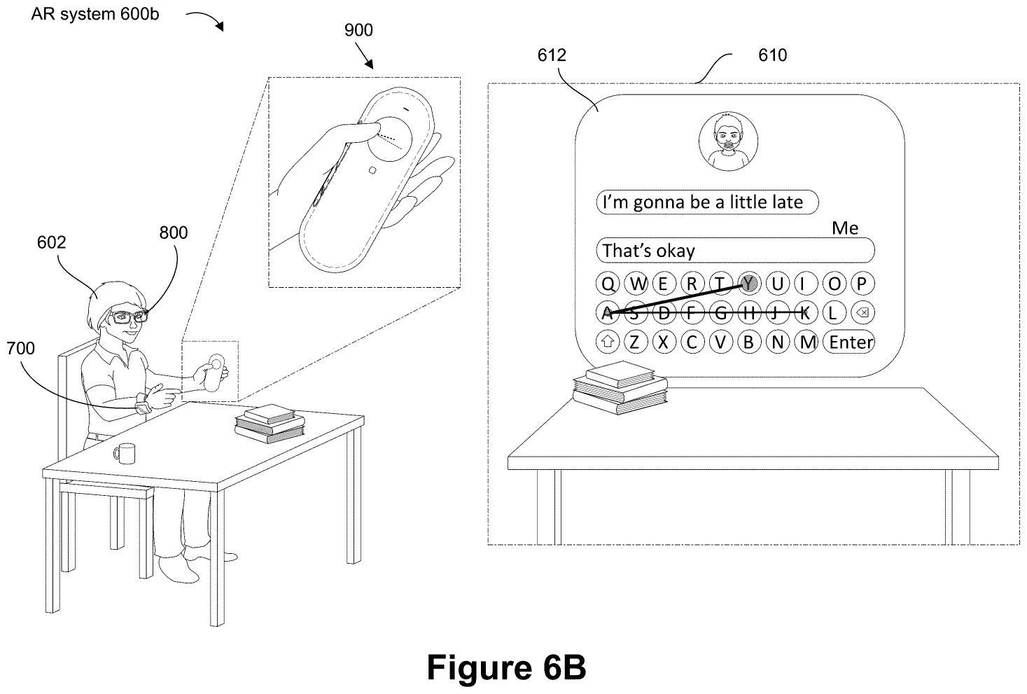

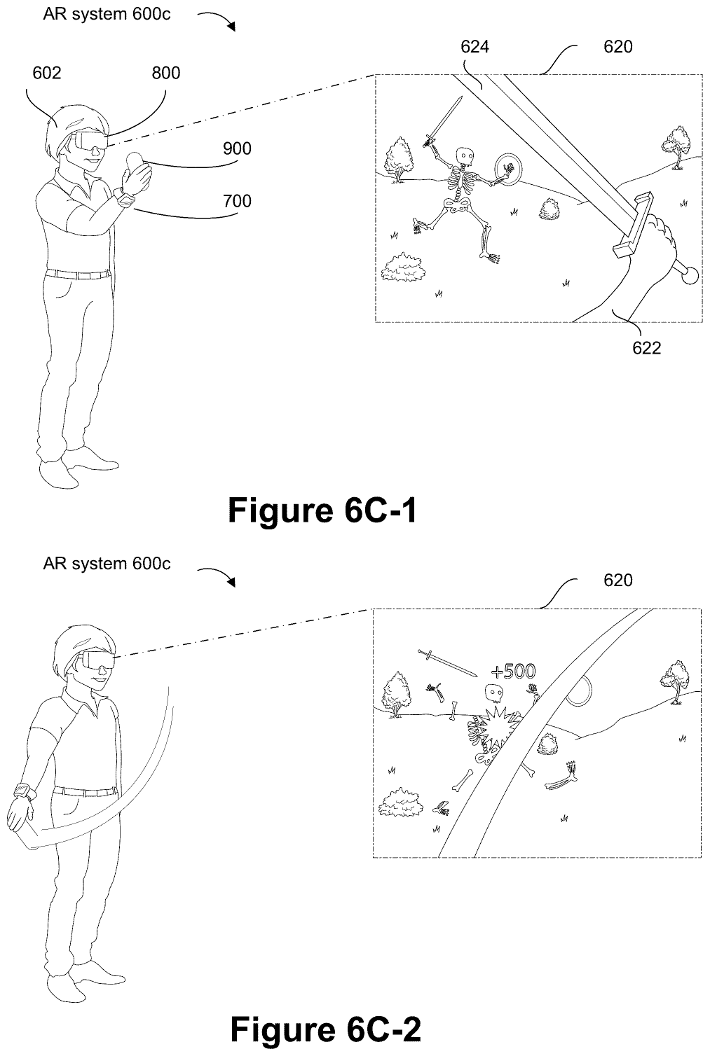

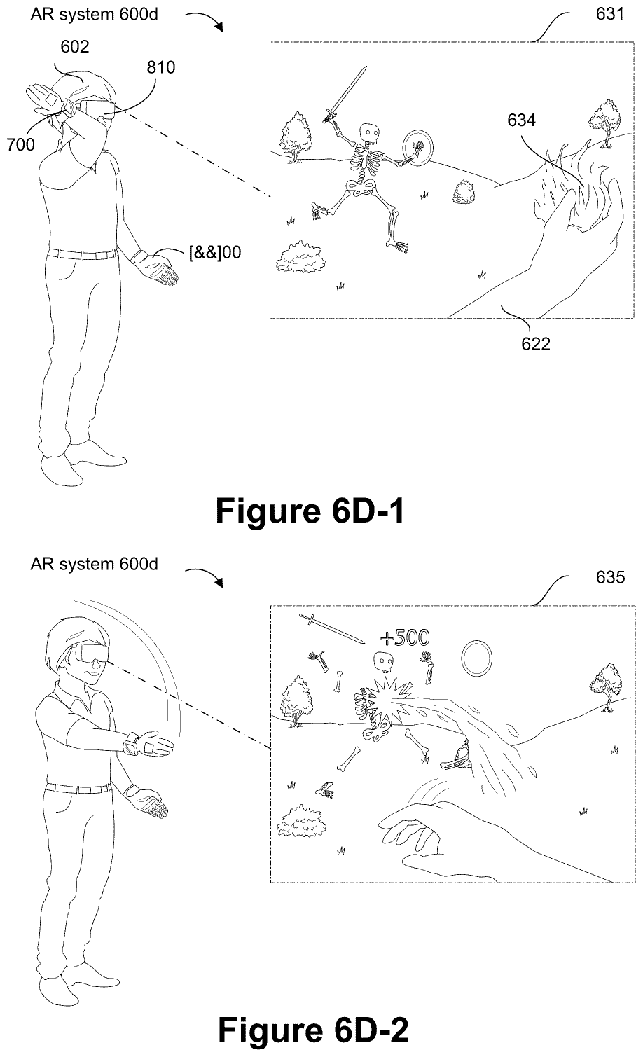

FIGS. 6A, 6B, 6C-1, 6C-2, 6D-1, and 6D-2 illustrate example AR systems, in accordance with some embodiments. FIG. 6A shows a first AR system 600a and first example user interactions using a wrist-wearable device 700, a head-wearable device (e.g., AR device 800), and/or a handheld intermediary processing device (HIPD) 900. FIG. 6B shows a second AR system 600b and second example user interactions using a wrist-wearable device 700, AR device 800, and/or an HIPD 900. FIGS. 6C-1 and 6C-2 show a third AR system 600c and third example user interactions using a wrist-wearable device 700, a head-wearable device (e.g., virtual-reality (VR) device 810), and/or an HIPD 900. FIGS. 6D-1 and 6D-2 show a fourth AR system 600d and fourth example user interactions using a wrist-wearable device 700, VR device 810, and/or a smart textile-based garment (e.g., wearable gloves or haptic gloves). As the skilled artisan will appreciate upon reading the descriptions provided herein, the above-example AR systems (described in detail below) can perform various functions and/or operations.

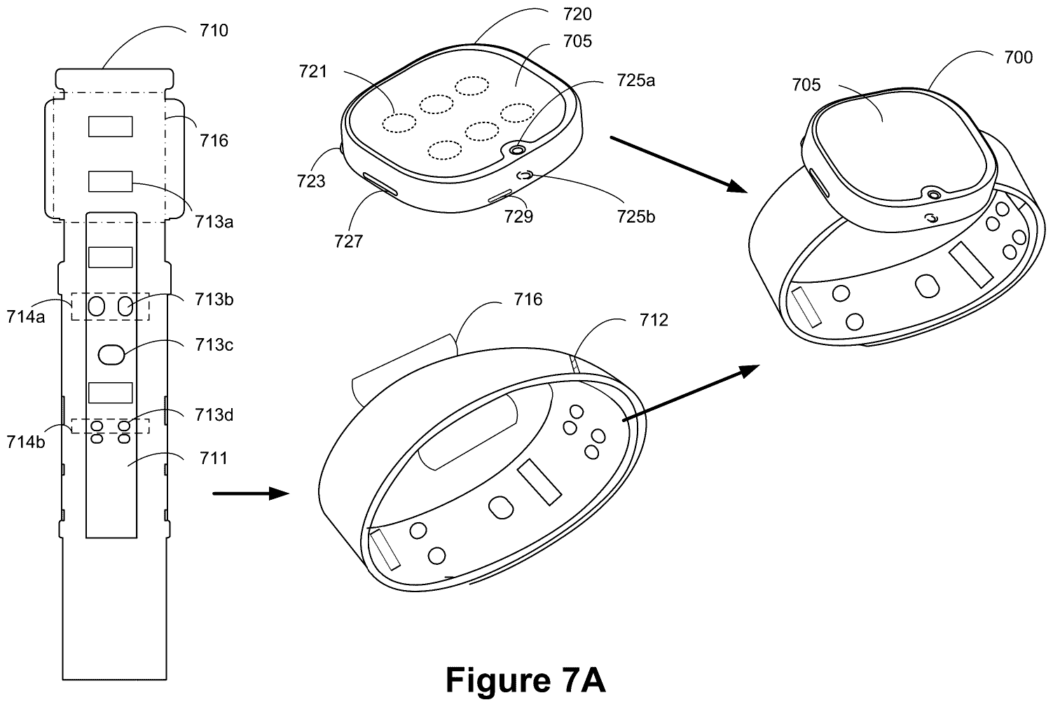

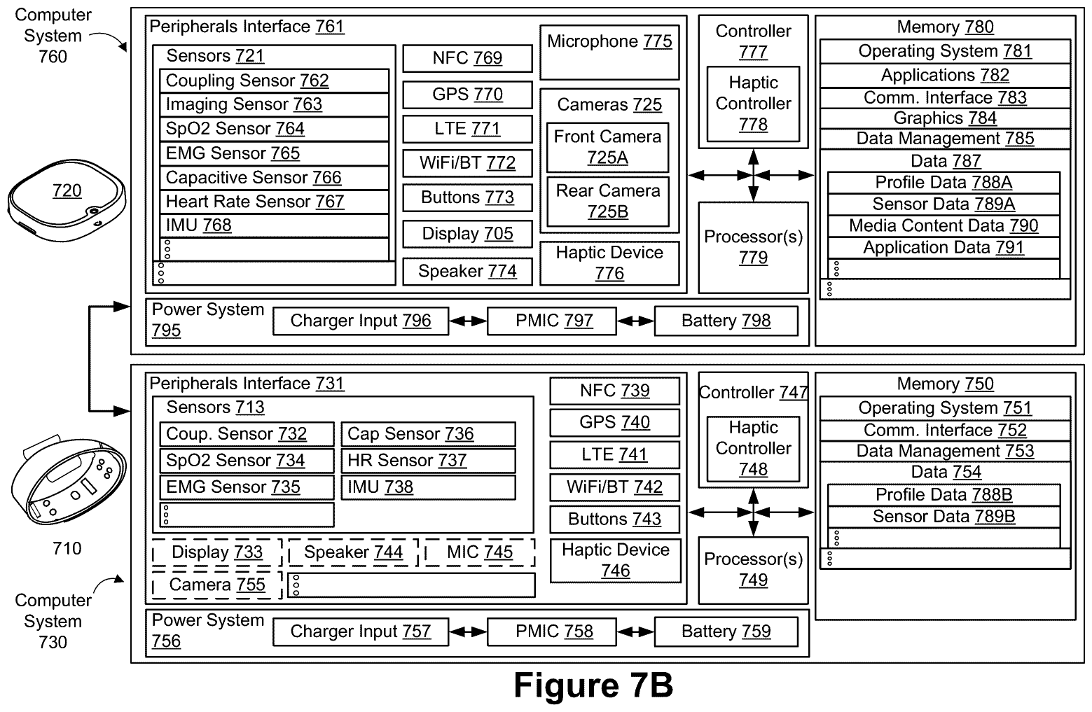

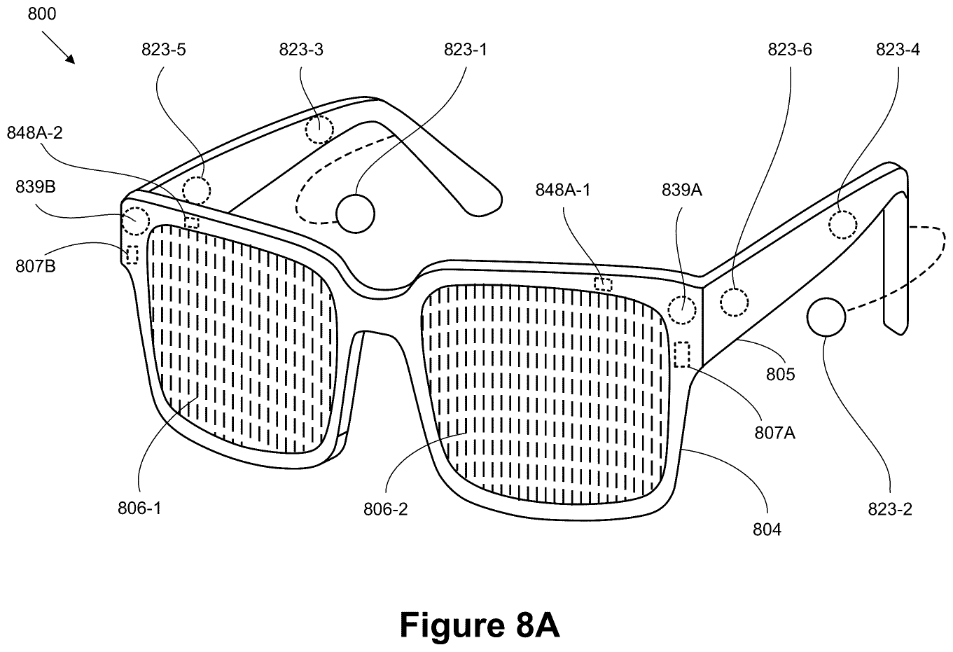

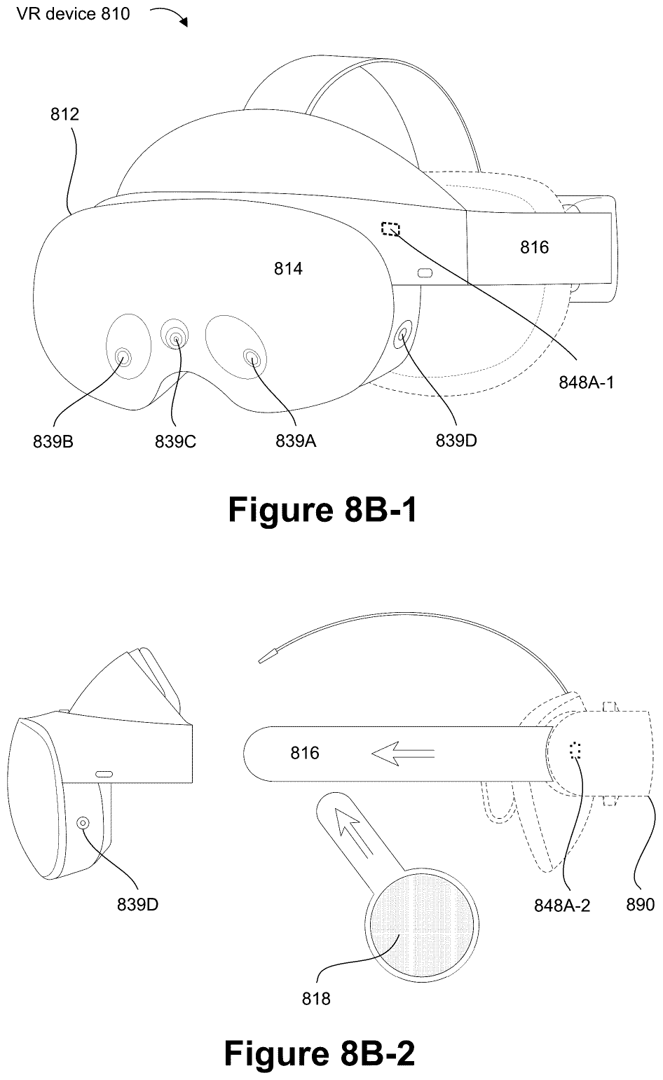

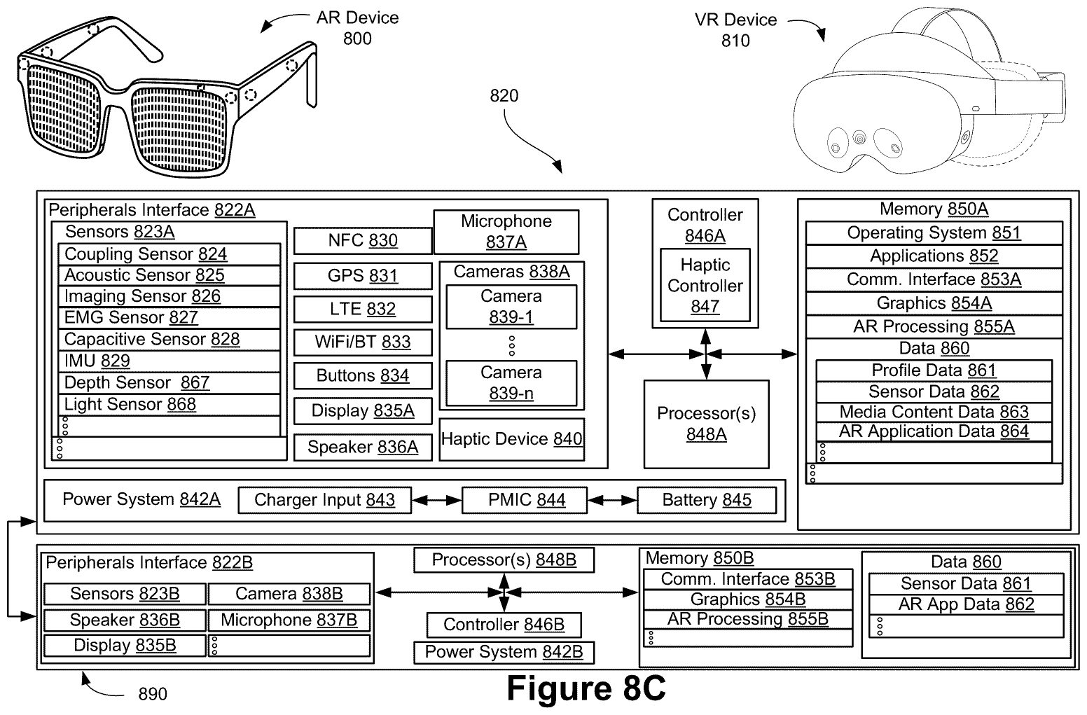

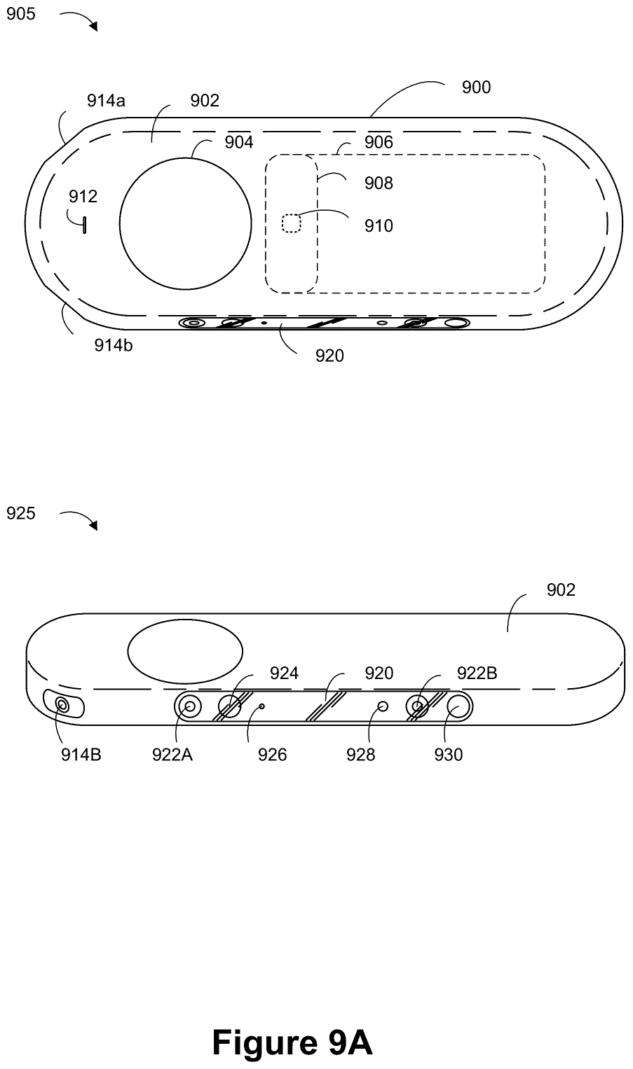

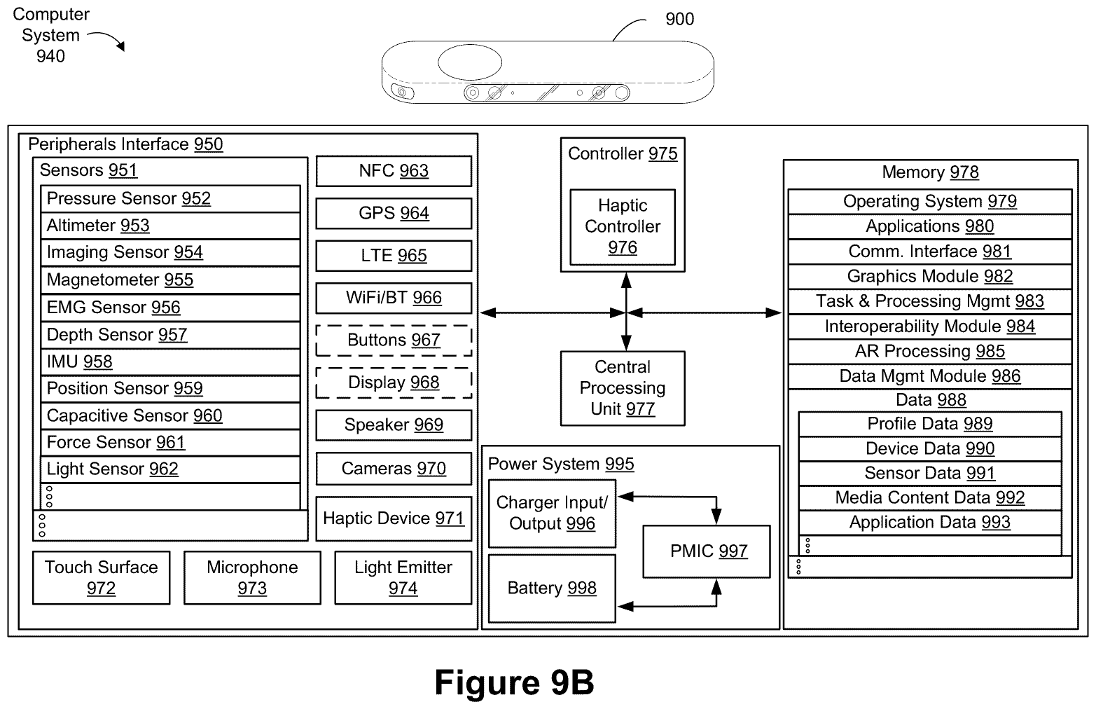

The wrist-wearable device 700 and its constituent components are described below in reference to FIGS. 7A-7B, the head-wearable devices and their constituent components are described below in reference to FIGS. 8A-8D, and the HIPD 900 and its constituent components are described below in reference to FIGS. 9A-9B. The wrist-wearable device 700, the head-wearable devices, and/or the HIPD 900 can communicatively couple via a network 625 (e.g., cellular, near field, Wi-Fi, personal area network, or wireless LAN). Additionally, the wrist-wearable device 700, the head-wearable devices, and/or the HIPD 900 can also communicatively couple with one or more servers 630, computers 640 (e.g., laptops or computers), mobile devices 650 (e.g., smartphones or tablets), and/or other electronic devices via the network 625 (e.g., cellular, near field, Wi-Fi, personal area network, or wireless LAN).

Turning to FIG. 6A, a user 602 is shown wearing the wrist-wearable device 700 and the AR device 800, and having the HIPD 900 on their desk. The wrist-wearable device 700, the AR device 800, and the HIPD 900 facilitate user interaction with an AR environment. In particular, as shown by the first AR system 600a, the wrist-wearable device 700, the AR device 800, and/or the HIPD 900 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 700, the AR device 800, and/or the HIPD 900.

The user 602 can use any of the wrist-wearable device 700, the AR device 800, and/or the HIPD 900 to provide user inputs. For example, the user 602 can perform one or more hand gestures that are detected by the wrist-wearable device 700 (e.g., using one or more EMG sensors and/or IMUs, described below in reference to FIGS. 7A-7B) and/or AR device 800 (e.g., using one or more image sensors or cameras, described below in reference to FIGS. 8A-8B) to provide a user input. Alternatively, or additionally, the user 602 can provide a user input via one or more touch surfaces of the wrist-wearable device 700, the AR device 800, and/or the HIPD 900, and/or voice commands captured by a microphone of the wrist-wearable device 700, the AR device 800, and/or the HIPD 900. In some embodiments, the wrist-wearable device 700, the AR device 800, and/or the HIPD 900 include a digital assistant to help the user in providing a user input (e.g., completing a sequence of operations, suggesting different operations or commands, providing reminders, or confirming a command). In some embodiments, the user 602 can provide a user input via one or more facial gestures and/or facial expressions. For example, cameras of the wrist-wearable device 700, the AR device 800, and/or the HIPD 900 can track the user 602's eyes for navigating a user interface.

The wrist-wearable device 700, the AR device 800, and/or the HIPD 900 can operate alone or in conjunction to allow the user 602 to interact with the AR environment. In some embodiments, the HIPD 900 is configured to operate as a central hub or control center for the wrist-wearable device 700, the AR device 800, and/or another communicatively coupled device. For example, the user 602 can provide an input to interact with the AR environment at any of the wrist-wearable device 700, the AR device 800, and/or the HIPD 900, and the HIPD 900 can identify one or more back-end and front-end tasks to cause the performance of the requested interaction and distribute instructions to cause the performance of the one or more back-end and front-end tasks at the wrist-wearable device 700, the AR device 800, and/or the HIPD 900. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 9A-9B, the HIPD 900 can perform the back-end tasks and provide the wrist-wearable device 700 and/or the AR device 800 operational data corresponding to the performed back-end tasks such that the wrist-wearable device 700 and/or the AR device 800 can perform the front-end tasks. In this way, the HIPD 900, which has more computational resources and greater thermal headroom than the wrist-wearable device 700 and/or the AR device 800, performs computationally intensive tasks and reduces the computer resource utilization and/or power usage of the wrist-wearable device 700 and/or the AR device 800.

In the example shown by the first AR system 600a, the HIPD 900 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 900 performs back-end tasks for processing and/or rendering image data (and other data) associated with the AR video call and provides operational data associated with the performed back-end tasks to the AR device 800 such that the AR device 800 performs front-end tasks for presenting the AR video call (e.g., presenting the avatar 604 and the digital representation of the contact 606).

In some embodiments, the HIPD 900 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 900. In particular, the HIPD 900 and the AR device 800 operate in conjunction to determine a location for presenting the avatar 604 and the digital representation of the contact 606. In some embodiments, information can be presented within a predetermined distance from the HIPD 900 (e.g., within five meters). For example, as shown in the first AR system 600a, virtual object 608 is presented on the desk some distance from the HIPD 900. Similar to the above example, the HIPD 900 and the AR device 800 can operate in conjunction to determine a location for presenting the virtual object 608. Alternatively, in some embodiments, presentation of information is not bound by the HIPD 900. More specifically, the avatar 604, the digital representation of the contact 606, and the virtual object 608 do not have to be presented within a predetermined distance of the HIPD 900.

User inputs provided at the wrist-wearable device 700, the AR device 800, and/or the HIPD 900 are coordinated such that the user can use any device to initiate, continue, and/or complete an operation. For example, the user 602 can provide a user input to the AR device 800 to cause the AR device 800 to present the virtual object 608 and, while the virtual object 608 is presented by the AR device 800, the user 602 can provide one or more hand gestures via the wrist-wearable device 700 to interact and/or manipulate the virtual object 608.

FIG. 6B shows the user 602 wearing the wrist-wearable device 700 and the AR device 800, and holding the HIPD 900. In the second AR system 600b, the wrist-wearable device 700, the AR device 800, and/or the HIPD 900 are used to receive and/or provide one or more messages to a contact of the user 602. In particular, the wrist-wearable device 700, the AR device 800, and/or the HIPD 900 detect and coordinate one or more user inputs to initiate a messaging application and prepare a response to a received message via the messaging application.

In some embodiments, the user 602 initiates, via a user input, an application on the wrist-wearable device 700, the AR device 800, and/or the HIPD 900 that causes the application to initiate on at least one device. For example, in the second AR system 600b, the user 602 performs a hand gesture associated with a command for initiating a messaging application (represented by messaging user interface 612), the wrist-wearable device 700 detects the hand gesture, and, based on a determination that the user 602 is wearing AR device 800, causes the AR device 800 to present a messaging user interface 612 of the messaging application. The AR device 800 can present the messaging user interface 612 to the user 602 via its display (e.g., as shown by user 602's field of view 610). In some embodiments, the application is initiated and can be run on the device (e.g., the wrist-wearable device 700, the AR device 800, and/or the HIPD 900) that detects the user input to initiate the application, and the device provides another device with operational data to cause the presentation of the messaging application. For example, the wrist-wearable device 700 can detect the user input to initiate a messaging application, initiate and run the messaging application, and provide operational data to the AR device 800 and/or the HIPD 900 to cause presentation of the messaging application. Alternatively, the application can be initiated and run at a device other than the device that detected the user input. For example, the wrist-wearable device 700 can detect the hand gesture associated with initiating the messaging application and cause the HIPD 900 to run the messaging application and coordinate the presentation of the messaging application.

Further, the user 602 can provide a user input provided at the wrist-wearable device 700, the AR device 800, and/or the HIPD 900 to continue and/or complete an operation initiated at another device. For example, after initiating the messaging application via the wrist-wearable device 700 and while the AR device 800 presents the messaging user interface 612, the user 602 can provide an input at the HIPD 900 to prepare a response (e.g., shown by the swipe gesture performed on the HIPD 900). The user 602's gestures performed on the HIPD 900 can be provided and/or displayed on another device. For example, the user 602's swipe gestures performed on the HIPD 900 are displayed on a virtual keyboard of the messaging user interface 612 displayed by the AR device 800.

In some embodiments, the wrist-wearable device 700, the AR device 800, the HIPD 900, and/or other communicatively coupled devices can present one or more notifications to the user 602. The notification can be an indication of a new message, an incoming call, an application update, a status update, etc. The user 602 can select the notification via the wrist-wearable device 700, the AR device 800, or the HIPD 900 and cause presentation of an application or operation associated with the notification on at least one device. For example, the user 602 can receive a notification that a message was received at the wrist-wearable device 700, the AR device 800, the HIPD 900, and/or other communicatively coupled device and provide a user input at the wrist-wearable device 700, the AR device 800, and/or the HIPD 900 to review the notification, and the device detecting the user input can cause an application associated with the notification to be initiated and/or presented at the wrist-wearable device 700, the AR device 800, and/or the HIPD 900.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 800 can present to the user 602 game application data and the HIPD 900 can use a controller to provide inputs to the game. Similarly, the user 602 can use the wrist-wearable device 700 to initiate a camera of the AR device 800, and the user can use the wrist-wearable device 700, the AR device 800, and/or the HIPD 900 to manipulate the image capture (e.g., zoom in or out or apply filters) and capture image data.

Turning to FIGS. 6C-1 and 6C-2, the user 602 is shown wearing the wrist-wearable device 700 and a VR device 810, and holding the HIPD 900. In the third AR system 600c, the wrist-wearable device 700, the VR device 810, and/or the HIPD 900 are used to interact within an AR environment, such as a VR game or other AR application. While the VR device 810 presents a representation of a VR game (e.g., first AR game environment 620) to the user 602, the wrist-wearable device 700, the VR device 810, and/or the HIPD 900 detect and coordinate one or more user inputs to allow the user 602 to interact with the VR game.

In some embodiments, the user 602 can provide a user input via the wrist-wearable device 700, the VR device 810, and/or the HIPD 900 that causes an action in a corresponding AR environment. For example, the user 602 in the third AR system 600c (shown in FIG. 6C-1) raises the HIPD 900 to prepare for a swing in the first AR game environment 620. The VR device 810, responsive to the user 602 raising the HIPD 900, causes the AR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors 958 (e.g., SLAM cameras or other cameras discussed below in FIGS. 9A and 9B) of the HIPD 900 can be used to detect a position of the 900 relative to the user 602's body, such that the virtual object can be positioned appropriately within the first AR game environment 620; sensor data from the wrist-wearable device 700 can be used to detect a velocity at which the user 602 raises the HIPD 900, such that the AR representation of the user 622 and the virtual sword 624 are synchronized with the user 602's movements; and image sensors 826 (FIGS. 8A-8C) of the VR device 810 can be used to represent the user 602's body, boundary conditions, or real-world objects within the first AR game environment 620.

In FIG. 6C-2, the user 602 performs a downward swing while holding the HIPD 900. The user 602's downward swing is detected by the wrist-wearable device 700, the VR device 810, and/or the HIPD 900 and a corresponding action is performed in the first AR game environment 620. In some embodiments, the data captured by each device is used to improve the user's experience within the AR environment. For example, sensor data of the wrist-wearable device 700 can be used to determine a speed and/or force at which the downward swing is performed and image sensors of the HIPD 900 and/or the VR device 810 can be used to determine a location of the swing and how it should be represented in the first AR game environment 620, which, in turn, can be used as inputs for the AR environment (e.g., game mechanics, which can use detected speed, force, locations, and/or aspects of the user 602's actions to classify a user's inputs (e.g., user performs a light strike, hard strike, critical strike, glancing strike, or miss) or calculate an output (e.g., amount of damage)).

While the wrist-wearable device 700, the VR device 810, and/or the HIPD 900 are described as detecting user inputs, in some embodiments, user inputs are detected at a single device (with the single device being responsible for distributing signals to the other devices for performing the user input). For example, the HIPD 900 can operate an application for generating the first AR game environment 620 and provide the VR device 810 with corresponding data for causing the presentation of the first AR game environment 620, as well as detect the 602's movements (while holding the HIPD 900) to cause the performance of corresponding actions within the first AR game environment 620. Additionally or alternatively, in some embodiments, operational data (e.g., sensor data, image data, application data, device data, and/or other data) of one or more devices is provided to a single device (e.g., the HIPD 900) to process the operational data and cause respective devices to perform an action associated with processed operational data.

In FIGS. 6D-1 and 6D-2, the user 602 is shown wearing the wrist-wearable device 700, the VR device 810, and smart textile-based garments. In the fourth AR system 600d, the wrist-wearable device 700, the VR device 810, and/or the smart textile-based garments are used to interact within an AR environment (e.g., any AR system described above in reference to FIGS. 6A-6C-2). While the VR device 810 presents a representation of a VR game (e.g., second AR game environment 635) to the user 602, the wrist-wearable device 700, the VR device 810, and/or the smart textile-based garments detect and coordinate one or more user inputs to allow the user 602 to interact with the AR environment.

In some embodiments, the user 602 can provide a user input via the wrist-wearable device 700, the VR device 810, and/or the smart textile-based garments that causes an action in a corresponding AR environment. For example, the user 602 in the fourth AR system 600d (shown in FIG. 6D-1) raises a hand wearing the smart textile-based garments to prepare to cast a spell or throw an object within the second AR game environment 635. The VR device 810, responsive to the user 602 holding up their hand (wearing smart textile-based garments), causes the AR representation of the user 622 to perform a similar action (e.g., hold a virtual object or throw a fireball 634). In some embodiments, each device uses respective sensor data and/or image data to detect the user input and provides an accurate representation of the user 602's motion.

In FIG. 6D-2, the user 602 performs a throwing motion while wearing the smart textile-based garment. The user 602's throwing motion is detected by the wrist-wearable device 700, the VR device 810, and/or the smart textile-based garments, and a corresponding action is performed in the second AR game environment 635. As described above, the data captured by each device is used to improve the user's experience within the AR environment. Although not shown, the smart textile-based garments can be used in conjunction with an AR device 810 and/or an HIPD 900.

Having discussed example AR systems, devices for interacting with such AR systems, and other computing systems more generally, devices and components will now be discussed in greater detail below. Some definitions of devices and components that can be included in some or all of the example devices discussed below are defined here for ease of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 7A and 7B illustrate an example wrist-wearable device 700, in accordance with some embodiments. FIG. 7A illustrates components of the wrist-wearable device 700, which can be used individually or in combination, including combinations that include other electronic devices and/or electronic components.

FIG. 7A shows a wearable band 710 and a watch body 720 (or capsule) being coupled, as discussed below, to form the wrist-wearable device 700. The wrist-wearable device 700 can perform various functions and/or operations associated with navigating through user interfaces and selectively opening applications, as well as the functions and/or operations.

As will be described in more detail below, operations executed by the wrist-wearable device 700 can include (i) presenting content to a user (e.g., displaying visual content via a display 705); (ii) detecting (e.g., sensing) user input (e.g., sensing a touch on peripheral button 723 and/or at a touch screen of the display 705, a hand gesture detected by sensors (e.g., biopotential sensors)); (iii) sensing biometric data via one or more sensors 713 (e.g., neuromuscular signals, heart rate, temperature, or sleep); messaging (e.g., text, speech, or video); image capture via one or more imaging devices or cameras 725; wireless communications (e.g., cellular, near field, Wi-Fi, or personal area network); location determination; financial transactions; providing haptic feedback; alarms; notifications; biometric authentication; health monitoring; and/or sleep monitoring.

The above-example functions can be executed independently in the watch body 720, independently in the wearable band 710, and/or via an electronic communication between the watch body 720 and the wearable band 710. In some embodiments, functions can be executed on the wrist-wearable device 700 while an AR environment is being presented (e.g., via one of the AR systems 600a to 600d). As the skilled artisan will appreciate upon reading the descriptions provided herein, the novel wearable devices described herein can be used with other types of AR environments.

The wearable band 710 can be configured to be worn by a user such that an inner (or inside) surface of the wearable structure 711 of the wearable band 710 is in contact with the user's skin. When worn by a user, sensors 713 contact the user's skin. The sensors 713 can sense biometric data such as a user's heart rate, saturated oxygen level, temperature, sweat level, neuromuscular-signal sensors, or a combination thereof. The sensors 713 can also sense data about a user's environment, including a user's motion, altitude, location, orientation, gait, acceleration, position, or a combination thereof. In some embodiments, the sensors 713 are configured to track a position and/or motion of the wearable band 710. The one or more sensors 713 can include any of the sensors defined above and/or discussed below with respect to FIG. 7B.

The one or more sensors 713 can be distributed on an inside and/or an outside surface of the wearable band 710. In some embodiments, the one or more sensors 713 are uniformly spaced along the wearable band 710. Alternatively, in some embodiments, the one or more sensors 713 are positioned at distinct points along the wearable band 710. As shown in FIG. 7A, the one or more sensors 713 can be the same or distinct. For example, in some embodiments, the one or more sensors 713 can be shaped as a pill (e.g., sensor 713a), an oval, a circle, a square, an oblong (e.g., sensor 713c), and/or any other shape that maintains contact with the user's skin (e.g., such that neuromuscular signal and/or other biometric data can be accurately measured at the user's skin). In some embodiments, the one or more sensors 713 are aligned to form pairs of sensors (e.g., for sensing neuromuscular signals based on differential sensing within each respective sensor). For example, sensor 713b is aligned with an adjacent sensor to form sensor pair 714a, and sensor 713d is aligned with an adjacent sensor to form sensor pair 714b. In some embodiments, the wearable band 710 does not have a sensor pair. Alternatively, in some embodiments, the wearable band 710 has a predetermined number of sensor pairs (one pair of sensors, three pairs of sensors, four pairs of sensors, six pairs of sensors, or sixteen pairs of sensors).

The wearable band 710 can include any suitable number of sensors 713. In some embodiments, the amount and arrangements of sensors 713 depend on the particular application for which the wearable band 710 is used. For instance, a wearable band 710 configured as an armband, wristband, or chest-band may include a plurality of sensors 713 with a different number of sensors 713 and a different arrangement for each use case, such as medical use cases, compared to gaming or general day-to-day use cases.

In accordance with some embodiments, the wearable band 710 further includes an electrical ground electrode and a shielding electrode. The electrical ground and shielding electrodes, like the sensors 713, can be distributed on the inside surface of the wearable band 710 such that they contact a portion of the user's skin. For example, the electrical ground and shielding electrodes can be at an inside surface of coupling mechanism 716 or an inside surface of a wearable structure 711. The electrical ground and shielding electrodes can be formed and/or use the same components as the sensors 713. In some embodiments, the wearable band 710 includes more than one electrical ground electrode and more than one shielding electrode.

The sensors 713 can be formed as part of the wearable structure 711 of the wearable band 710. In some embodiments, the sensors 713 are flush or substantially flush with the wearable structure 711, such that they do not extend beyond the surface of the wearable structure 711. While flush with the wearable structure 711, the sensors 713 are still configured to contact the user's skin (e.g., via a skin-contacting surface). Alternatively, in some embodiments, the sensors 713 extend beyond the wearable structure 711 a predetermined distance (e.g., 0.1 mm to 2 mm) to make contact and depress into the user's skin. In some embodiments, the sensors 713 are coupled to an actuator (not shown) configured to adjust an extension height (e.g., a distance from the surface of the wearable structure 711) of the sensors 713 such that the sensors 713 make contact and depress into the user's skin. In some embodiments, the actuators adjust the extension height between 0.01 mm to 1.2 mm. This allows the user to customize the positioning of the sensors 713 to improve the overall comfort of the wearable band 710 when worn while still allowing the sensors 713 to contact the user's skin. In some embodiments, the sensors 713 are indistinguishable from the wearable structure 711 when worn by the user.

The wearable structure 711 can be formed of an elastic material, elastomers, etc., configured to be stretched and fitted to be worn by the user. In some embodiments, the wearable structure 711 is a textile or woven fabric. As described above, the sensors 713 can be formed as part of a wearable structure 711. For example, the sensors 713 can be molded into the wearable structure 711 or be integrated into a woven fabric (e.g., the sensors 713 can be sewn into the fabric and mimic the pliability of fabric (e.g., the sensors 713 can be constructed from a series of woven strands of fabric)).

The wearable structure 711 can include flexible electronic connectors that interconnect the sensors 713, the electronic circuitry, and/or other electronic components (described below in reference to FIG. 7B) that are enclosed in the wearable band 710. In some embodiments, the flexible electronic connectors are configured to interconnect the sensors 713, the electronic circuitry, and/or other electronic components of the wearable band 710 with respective sensors and/or other electronic components of another electronic device (e.g., watch body 720). The flexible electronic connectors are configured to move with the wearable structure 711 such that the user adjustment to the wearable structure 711 (e.g., resizing, pulling, or folding) does not stress or strain the electrical coupling of components of the wearable band 710.

As described above, the wearable band 710 is configured to be worn by a user. In particular, the wearable band 710 can be shaped or otherwise manipulated to be worn by a user. For example, the wearable band 710 can be shaped to have a substantially circular shape, such that it can be configured to be worn on the user's lower arm or wrist. Alternatively, the wearable band 710 can be shaped to be worn on another body part of the user, such as the user's upper arm (e.g., around a bicep), forearm, chest, legs, etc. The wearable band 710 can include a retaining mechanism 712 (e.g., a buckle or a hook and loop fastener) for securing the wearable band 710 to the user's wrist or other body part. While the wearable band 710 is worn by the user, the sensors 713 sense data (referred to as sensor data) from the user's skin. In particular, the sensors 713 of the wearable band 710 obtain (e.g., sense and record) neuromuscular signals.

The sensed data (e.g., sensed neuromuscular signals) can be used to detect and/or determine the user's intention to perform certain motor actions. In particular, the sensors 713 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 705 of the wrist-wearable device 700 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 713 can be used to provide a user with an enhanced interaction with a physical object (e.g., devices communicatively coupled with the wearable band 710) and/or a virtual object in an AR application generated by an AR system (e.g., user interface objects presented on the display 705 or another computing device (e.g., a smartphone)).

In some embodiments, the wearable band 710 includes one or more haptic devices 746 (FIG. 7B; e.g., a vibratory haptic actuator) that are configured to provide haptic feedback (e.g., a cutaneous and/or kinesthetic sensation) to the user's skin. The sensors 713 and/or the haptic devices 746 can be configured to operate in conjunction with multiple applications including, without limitation, health monitoring, social media, games, and AR (e.g., the applications associated with AR).

The wearable band 710 can also include a coupling mechanism 716 (e.g., a cradle or a shape of the coupling mechanism can correspond to the shape of the watch body 720 of the wrist-wearable device 700) for detachably coupling a capsule (e.g., a computing unit) or watch body 720 (via a coupling surface of the watch body 720) to the wearable band 710. In particular, the coupling mechanism 716 can be configured to receive a coupling surface proximate to the bottom side of the watch body 720 (e.g., a side opposite to a front side of the watch body 720 where the display 705 is located), such that a user can push the watch body 720 downward into the coupling mechanism 716 to attach the watch body 720 to the coupling mechanism 716. In some embodiments, the coupling mechanism 716 can be configured to receive a top side of the watch body 720 (e.g., a side proximate to the front side of the watch body 720 where the display 705 is located) that is pushed upward into the cradle, as opposed to being pushed downward into the coupling mechanism 716. In some embodiments, the coupling mechanism 716 is an integrated component of the wearable band 710 such that the wearable band 710 and the coupling mechanism 716 are a single unitary structure. In some embodiments, the coupling mechanism 716 is a type of frame or shell that allows the watch body 720 coupling surface to be retained within or on the wearable band 710 coupling mechanism 716 (e.g., a cradle, a tracker band, a support base, or a clasp).

The coupling mechanism 716 can allow for the watch body 720 to be detachably coupled to the wearable band 710 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 720 to the wearable band 710 and to decouple the watch body 720 from the wearable band 710. For example, a user can twist, slide, turn, push, pull, or rotate the watch body 720 relative to the wearable band 710, or a combination thereof, to attach the watch body 720 to the wearable band 710 and to detach the watch body 720 from the wearable band 710. Alternatively, as discussed below, in some embodiments, the watch body 720 can be decoupled from the wearable band 710 by actuation of the release mechanism 729.

The wearable band 710 can be coupled with a watch body 720 to increase the functionality of the wearable band 710 (e.g., converting the wearable band 710 into a wrist-wearable device 700, adding an additional computing unit and/or battery to increase computational resources and/or a battery life of the wearable band 710, or adding additional sensors to improve sensed data). As described above, the wearable band 710 (and the coupling mechanism 716) is configured to operate independently (e.g., execute functions independently) from watch body 720. For example, the coupling mechanism 716 can include one or more sensors 713 that contact a user's skin when the wearable band 710 is worn by the user and provide sensor data for determining control commands.

A user can detach the watch body 720 (or capsule) from the wearable band 710 in order to reduce the encumbrance of the wrist-wearable device 700 to the user. For embodiments in which the watch body 720 is removable, the watch body 720 can be referred to as a removable structure, such that in these embodiments the wrist-wearable device 700 includes a wearable portion (e.g., the wearable band 710) and a removable structure (the watch body 720).

Turning to the watch body 720, the watch body 720 can have a substantially rectangular or circular shape. The watch body 720 is configured to be worn by the user on their wrist or on another body part. More specifically, the watch body 720 is sized to be easily carried by the user, attached on a portion of the user's clothing, and/or coupled to the wearable band 710 (forming the wrist-wearable device 700). As described above, the watch body 720 can have a shape corresponding to the coupling mechanism 716 of the wearable band 710. In some embodiments, the watch body 720 includes a single release mechanism 729 or multiple release mechanisms (e.g., two release mechanisms 729 positioned on opposing sides of the watch body 720, such as spring-loaded buttons) for decoupling the watch body 720 and the wearable band 710. The release mechanism 729 can include, without limitation, a button, a knob, a plunger, a handle, a lever, a fastener, a clasp, a dial, a latch, or a combination thereof.

A user can actuate the release mechanism 729 by pushing, turning, lifting, depressing, shifting, or performing other actions on the release mechanism 729. Actuation of the release mechanism 729 can release (e.g., decouple) the watch body 720 from the coupling mechanism 716 of the wearable band 710, allowing the user to use the watch body 720 independently from wearable band 710 and vice versa. For example, decoupling the watch body 720 from the wearable band 710 can allow the user to capture images using rear-facing camera 725b. Although the coupling mechanism 716 is shown positioned at a corner of watch body 720, the release mechanism 729 can be positioned anywhere on watch body 720 that is convenient for the user to actuate. In addition, in some embodiments, the wearable band 710 can also include a respective release mechanism for decoupling the watch body 720 from the coupling mechanism 716. In some embodiments, the release mechanism 729 is optional and the watch body 720 can be decoupled from the coupling mechanism 716, as described above (e.g., via twisting or rotating).

The watch body 720 can include one or more peripheral buttons 723 and 727 for performing various operations at the watch body 720. For example, the peripheral buttons 723 and 727 can be used to turn on or wake (e.g., transition from a sleep state to an active state) the display 705, unlock the watch body 720, increase or decrease volume, increase or decrease brightness, interact with one or more applications, interact with one or more user interfaces. Additionally or alternatively, in some embodiments, the display 705 operates as a touch screen and allows the user to provide one or more inputs for interacting with the watch body 720.

In some embodiments, the watch body 720 includes one or more sensors 721. The sensors 721 of the watch body 720 can be the same or distinct from the sensors 713 of the wearable band 710. The sensors 721 of the watch body 720 can be distributed on an inside and/or an outside surface of the watch body 720. In some embodiments, the sensors 721 are configured to contact a user's skin when the watch body 720 is worn by the user. For example, the sensors 721 can be placed on the bottom side of the watch body 720 and the coupling mechanism 716 can be a cradle with an opening that allows the bottom side of the watch body 720 to directly contact the user's skin. Alternatively, in some embodiments, the watch body 720 does not include sensors that are configured to contact the user's skin (e.g., including sensors internal and/or external to the watch body 720 that are configured to sense data of the watch body 720 and the watch body 720's surrounding environment). In some embodiments, the sensors 713 are configured to track a position and/or motion of the watch body 720.

The watch body 720 and the wearable band 710 can share data using a wired communication method (e.g., a Universal Asynchronous Receiver/Transmitter (UART) or a USB transceiver) and/or a wireless communication method (e.g., near-field communication or Bluetooth). For example, the watch body 720 and the wearable band 710 can share data sensed by the sensors 713 and 721, as well as application- and device-specific information (e.g., active and/or available applications), output devices (e.g., display or speakers), and/or input devices (e.g., touch screens, microphones, or imaging sensors).

In some embodiments, the watch body 720 can include, without limitation, a front-facing camera 725a and/or a rear-facing camera 725b, sensors 721 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 7B; imaging sensor 763), a touch sensor, or a sweat sensor). In some embodiments, the watch body 720 can include one or more haptic devices 776 (FIG. 7B; a vibratory haptic actuator) that is configured to provide haptic feedback (e.g., a cutaneous and/or kinesthetic sensation) to the user. The sensors 721 and/or the haptic device 776 can also be configured to operate in conjunction with multiple applications, including, without limitation, health-monitoring applications, social media applications, game applications, and AR applications (e.g., the applications associated with AR).

As described above, the watch body 720 and the wearable band 710, when coupled, can form the wrist-wearable device 700. When coupled, the watch body 720 and wearable band 710 operate as a single device to execute functions (e.g., operations, detections, or communications) described herein. In some embodiments, each device is provided with particular instructions for performing the one or more operations of the wrist-wearable device 700. For example, in accordance with a determination that the watch body 720 does not include neuromuscular-signal sensors, the wearable band 710 can include alternative instructions for performing associated instructions (e.g., providing sensed neuromuscular-signal data to the watch body 720 via a different electronic device). Operations of the wrist-wearable device 700 can be performed by the watch body 720 alone or in conjunction with the wearable band 710 (e.g., via respective processors and/or hardware components) and vice versa. In some embodiments, operations of the wrist-wearable device 700, the watch body 720, and/or the wearable band 710 can be performed in conjunction with one or more processors and/or hardware components of another communicatively coupled device (e.g., FIGS. 9A-9B; the HIPD 900).

As described below with reference to the block diagram of FIG. 7B, the wearable band 710 and/or the watch body 720 can each include independent resources required to independently execute functions. For example, the wearable band 710 and/or the watch body 720 can each include a power source (e.g., a battery), a memory, data storage, a processor (e.g., a CPU), communications, a light source, and/or input/output devices.

FIG. 7B shows block diagrams of a computing system 730 corresponding to the wearable band 710 and a computing system 760 corresponding to the watch body 720, according to some embodiments. A computing system of the wrist-wearable device 700 includes a combination of components of the wearable band computing system 730 and the watch body computing system 760, in accordance with some embodiments.

The watch body 720 and/or the wearable band 710 can include one or more components shown in watch body computing system 760. In some embodiments, a single integrated circuit includes all or a substantial portion of the components of the watch body computing system 760 that are included in a single integrated circuit. Alternatively, in some embodiments, components of the watch body computing system 760 are included in a plurality of integrated circuits that are communicatively coupled. In some embodiments, the watch body computing system 760 is configured to couple (e.g., via a wired or wireless connection) with the wearable band computing system 730, which allows the computing systems to share components, distribute tasks, and/or perform other operations described herein (individually or as a single device).

The watch body computing system 760 can include one or more processors 779, a controller 777, a peripherals interface 761, a power system 795, and memory (e.g., a memory 780), each of which are defined above and described in more detail below.

The power system 795 can include a charger input 796, a power-management integrated circuit (PMIC) 797, and a battery 798, each of which are defined above. In some embodiments, a watch body 720 and a wearable band 710 can have respective charger inputs (e.g., charger inputs 796 and 757), respective batteries (e.g., batteries 798 and 759), and can share power with each other (e.g., the watch body 720 can power and/or charge the wearable band 710 and vice versa). Although watch body 720 and/or the wearable band 710 can include respective charger inputs, a single charger input can charge both devices when coupled. The watch body 720 and the wearable band 710 can receive a charge using a variety of techniques. In some embodiments, the watch body 720 and the wearable band 710 can use a wired charging assembly (e.g., power cords) to receive the charge. Alternatively, or in addition, the watch body 720 and/or the wearable band 710 can be configured for wireless charging. For example, a portable charging device can be designed to mate with a portion of watch body 720 and/or wearable band 710 and wirelessly deliver usable power to a battery of watch body 720 and/or wearable band 710. The watch body 720 and the wearable band 710 can have independent power systems (e.g., power systems 795 and 756) to enable each to operate independently. The watch body 720 and wearable band 710 can also share power (e.g., one can charge the other) via respective PMICs (e.g., PMICs 797 and 758) that can share power over power and ground conductors and/or over wireless charging antennas.

In some embodiments, the peripherals interface 761 can include one or more sensors 721, many of which listed below are defined above. The sensors 721 can include one or more coupling sensors 762 for detecting when the watch body 720 is coupled with another electronic device (e.g., a wearable band 710). The sensors 721 can include imaging sensors 763 (one or more of the cameras 725 and/or separate imaging sensors 763 (e.g., thermal-imaging sensors)). In some embodiments, the sensors 721 include one or more SpO₂ sensors 764. In some embodiments, the sensors 721 include one or more biopotential-signal sensors (e.g., EMG sensors 765, which may be disposed on a user-facing portion of the watch body 720 and/or the wearable band 710). In some embodiments, the sensors 721 include one or more capacitive sensors 766. In some embodiments, the sensors 721 include one or more heart rate sensors 767. In some embodiments, the sensors 721 include one or more IMUs 768. In some embodiments, one or more IMUs 768 can be configured to detect movement of a user's hand or other location that the watch body 720 is placed or held.

In some embodiments, the peripherals interface 761 includes an NFC component 769, a GPS component 770, a long-term evolution (LTE) component 771, and/or a Wi-Fi and/or Bluetooth communication component 772. In some embodiments, the peripherals interface 761 includes one or more buttons 773 (e.g., the peripheral buttons 723 and 727 in FIG. 7A), which, when selected by a user, cause operations to be performed at the watch body 720. In some embodiments, the peripherals interface 761 includes one or more indicators, such as a light-emitting diode (LED), to provide a user with visual indicators (e.g., message received, low battery, an active microphone, and/or a camera).

The watch body 720 can include at least one display 705 for displaying visual representations of information or data to the user, including user-interface elements and/or three-dimensional (3D) virtual objects. The display can also include a touch screen for inputting user inputs, such as touch gestures, swipe gestures, and the like. The watch body 720 can include at least one speaker 774 and at least one microphone 775 for providing audio signals to the user and receiving audio input from the user. The user can provide user inputs through the microphone 775 and can also receive audio output from the speaker 774 as part of a haptic event provided by the haptic controller 778. The watch body 720 can include at least one camera 725, including a front-facing camera 725a and a rear-facing camera 725b. The cameras 725 can include ultra-wide-angle cameras, wide-angle cameras, fish-eye cameras, spherical cameras, telephoto cameras, depth-sensing cameras, or other types of cameras.

The watch body computing system 760 can include one or more haptic controllers 778 and associated componentry (e.g., haptic devices 776) for providing haptic events at the watch body 720 (e.g., a vibrating sensation or audio output in response to an event at the watch body 720). The haptic controllers 778 can communicate with one or more haptic devices 776, such as electroacoustic devices, including a speaker of the one or more speakers 774 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 778 can provide haptic events to respective haptic actuators that are capable of being sensed by a user of the watch body 720. In some embodiments, the one or more haptic controllers 778 can receive input signals from an application of the applications 782.

In some embodiments, the computer system 730 and/or the computer system 760 can include memory 780, which can be controlled by a memory controller of the one or more controllers 777 and/or one or more processors 779. In some embodiments, software components stored in the memory 780 include one or more applications 782 configured to perform operations at the watch body 720. In some embodiments, the one or more applications 782 include games, word processors, messaging applications, calling applications, web browsers, social media applications, media streaming applications, financial applications, calendars, clocks, etc. In some embodiments, software components stored in the memory 780 include one or more communication interface modules 783 as defined above. In some embodiments, software components stored in the memory 780 include one or more graphics modules 784 for rendering, encoding, and/or decoding audio and/or visual data; and one or more data management modules 785 for collecting, organizing, and/or providing access to the data 787 stored in memory 780. In some embodiments, one or more of applications 782 and/or one or more modules can work in conjunction with one another to perform various tasks at the watch body 720.

In some embodiments, software components stored in the memory 780 can include one or more operating systems 781 (e.g., a Linux-based operating system, an Android operating system, etc.). The memory 780 can also include data 787. The data 787 can include profile data 788A, sensor data 789A, media content data 790, and application data 791.

It should be appreciated that the watch body computing system 760 is an example of a computing system within the watch body 720, and that the watch body 720 can have more or fewer components than shown in the watch body computing system 760, combine two or more components, and/or have a different configuration and/or arrangement of the components. The various components shown in watch body computing system 760 are implemented in hardware, software, firmware, or a combination thereof, including one or more signal processing and/or application-specific integrated circuits.

Turning to the wearable band computing system 730, one or more components that can be included in the wearable band 710 are shown. The wearable band computing system 730 can include more or fewer components than shown in the watch body computing system 760, combine two or more components, and/or have a different configuration and/or arrangement of some or all of the components. In some embodiments, all, or a substantial portion of the components of the wearable band computing system 730 are included in a single integrated circuit. Alternatively, in some embodiments, components of the wearable band computing system 730 are included in a plurality of integrated circuits that are communicatively coupled. As described above, in some embodiments, the wearable band computing system 730 is configured to couple (e.g., via a wired or wireless connection) with the watch body computing system 760, which allows the computing systems to share components, distribute tasks, and/or perform other operations described herein (individually or as a single device).

The wearable band computing system 730, similar to the watch body computing system 760, can include one or more processors 749, one or more controllers 747 (including one or more haptics controller 748), a peripherals interface 731 that can include one or more sensors 713 and other peripheral devices, power source (e.g., a power system 756), and memory (e.g., a memory 750) that includes an operating system (e.g., an operating system 751), data (e.g., data 754 including profile data 788B, sensor data 789B, etc.), and one or more modules (e.g., a communications interface module 752, a data management module 753, etc.).

The one or more sensors 713 can be analogous to sensors 721 of the computer system 760 in light of the definitions above. For example, sensors 713 can include one or more coupling sensors 732, one or more SpO₂ sensors 734, one or more EMG sensors 735, one or more capacitive sensors 736, one or more heart rate sensors 737, and one or more IMU sensors 738.

The peripherals interface 731 can also include other components analogous to those included in the peripheral interface 761 of the computer system 760, including an NFC component 739, a GPS component 740, an LTE component 741, a Wi-Fi and/or Bluetooth communication component 742, and/or one or more haptic devices 776 as described above in reference to peripherals interface 761. In some embodiments, the peripherals interface 731 includes one or more buttons 743, a display 733, a speaker 744, a microphone 745, and a camera 755. In some embodiments, the peripherals interface 731 includes one or more indicators, such as an LED.

It should be appreciated that the wearable band computing system 730 is an example of a computing system within the wearable band 710, and that the wearable band 710 can have more or fewer components than shown in the wearable band computing system 730, combine two or more components, and/or have a different configuration and/or arrangement of the components. The various components shown in wearable band computing system 730 can be implemented in one or a combination of hardware, software, and firmware, including one or more signal processing and/or application-specific integrated circuits.

The wrist-wearable device 700 with respect to FIG. 7A is an example of the wearable band 710 and the watch body 720 coupled, so the wrist-wearable device 700 will be understood to include the components shown and described for the wearable band computing system 730 and the watch body computing system 760. In some embodiments, wrist-wearable device 700 has a split architecture (e.g., a split mechanical architecture or a split electrical architecture) between the watch body 720 and the wearable band 710. In other words, all of the components shown in the wearable band computing system 730 and the watch body computing system 760 can be housed or otherwise disposed in a combined watch device 700, or within individual components of the watch body 720, wearable band 710, and/or portions thereof (e.g., a coupling mechanism 716 of the wearable band 710).

The techniques described above can be used with any device for sensing neuromuscular signals, including the arm-wearable devices of FIG. 7A-7B, but could also be used with other types of wearable devices for sensing neuromuscular signals (such as body-wearable or head-wearable devices that might have neuromuscular sensors closer to the brain or spinal column).

In some embodiments, a wrist-wearable device 700 can be used in conjunction with a head-wearable device described below (e.g., AR device 800 and VR device 810) and/or an HIPD 900, and the wrist-wearable device 700 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 800 and VR device 810.

### Example Head-Wearable Devices

FIGS. 8A, 8B-1, 8B-2, and 8C show example head-wearable devices, in accordance with some embodiments. Head-wearable devices can include, but are not limited to, AR devices 800 (e.g., AR or smart eyewear devices, such as smart glasses, smart monocles, smart contacts, etc.), VR devices 810 (e.g., VR headsets or head-mounted displays (HMDs)), or other ocularly coupled devices. The AR devices 800 and the VR devices 810 are instances of the head-wearable devices described in reference to FIGS. 1-5 herein, such that the head-wearable device should be understood to have the features of the AR devices 800 and/or the VR devices 810 and vice versa. The AR devices 800 and the VR devices 810 can perform various functions and/or operations associated with navigating through user interfaces and selectively opening applications.

In some embodiments, an AR system (e.g., FIGS. 6A-6D-2; AR systems 600a-600d) includes an AR device 800 (as shown in FIG. 8A) and/or VR device 810 (as shown in FIGS. 8B-1-B-2). In some embodiments, the AR device 800 and the VR device 810 can include one or more analogous components (e.g., components for presenting interactive AR environments, such as processors, memory, and/or presentation devices, including one or more displays and/or one or more waveguides), some of which are described in more detail with respect to FIG. 8C. The head-wearable devices can use display projectors (e.g., display projector assemblies 807A and 807B) and/or waveguides for projecting representations of data to a user. Some embodiments of head-wearable devices do not include displays.

FIG. 8A shows an example visual depiction of the AR device 800 (e.g., which may also be described herein as augmented-reality glasses and/or smart glasses). The AR device 800 can work in conjunction with additional electronic components that are not shown in FIGS. 8A, such as a wearable accessory device and/or an intermediary processing device, in electronic communication or otherwise configured to be used in conjunction with the AR device 800. In some embodiments, the wearable accessory device and/or the intermediary processing device may be configured to couple with the AR device 800 via a coupling mechanism in electronic communication with a coupling sensor 824, where the coupling sensor 824 can detect when an electronic device becomes physically or electronically coupled with the AR device 800. In some embodiments, the AR device 800 can be configured to couple to a housing (e.g., a portion of frame 804 or temple arms 805), which may include one or more additional coupling mechanisms configured to couple with additional accessory devices. The components shown in FIG. 8A can be implemented in hardware, software, firmware, or a combination thereof, including one or more signal-processing components and/or application-specific integrated circuits (ASICs).

The AR device 800 includes mechanical glasses components, including a frame 804 configured to hold one or more lenses (e.g., one or both lenses 806-1 and 806-2). One of ordinary skill in the art will appreciate that the AR device 800 can include additional mechanical components, such as hinges configured to allow portions of the frame 804 of the AR device 800 to be folded and unfolded, a bridge configured to span the gap between the lenses 806-1 and 806-2 and rest on the user's nose, nose pads configured to rest on the bridge of the nose and provide support for the AR device 800, earpieces configured to rest on the user's ears and provide additional support for the AR device 800, temple arms 805 configured to extend from the hinges to the earpieces of the AR device 800, and the like. One of ordinary skill in the art will further appreciate that some examples of the AR device 800 can include none of the mechanical components described herein. For example, smart contact lenses configured to present AR to users may not include any components of the AR device 800.

The lenses 806-1 and 806-2 can be individual displays or display devices (e.g., a waveguide for projected representations). The lenses 806-1 and 806-2 may act together or independently to present an image or series of images to a user. In some embodiments, the lenses 806-1 and 806-2 can operate in conjunction with one or more display projector assemblies 807A and 807B to present image data to a user. While the AR device 800 includes two displays, embodiments of this disclosure may be implemented in AR devices with a single near-eye display (NED) or more than two NEDs.

The AR device 800 includes electronic components, many of which will be described in more detail below with respect to FIG. 8C. Some example electronic components are illustrated in FIG. 8A, including sensors 823-1, 823-2, 823-3, 823-4, 823-5, and 823-6, which can be distributed along a substantial portion of the frame 804 of the AR device 800. The different types of sensors are described below in reference to FIG. 8C. The AR device 800 also includes a left camera 839A and a right camera 839B, which are located on different sides of the frame 804. And the eyewear device includes one or more processors 848A and 848B (e.g., an integral microprocessor, such as an ASIC) that is embedded into a portion of the frame 804.

FIGS. 8B-1 and 8B-2 show an example visual depiction of the VR device 810 (e.g., a head-mounted display (HMD) 812, also referred to herein as an AR headset, a head-wearable device, or a VR headset). The HMD 812 includes a front body 814 and a frame 816 (e.g., a strap or band) shaped to fit around a user's head. In some embodiments, the front body 814 and/or the frame 816 includes one or more electronic elements for facilitating presentation of and/or interactions with an AR and/or VR system (e.g., displays, processors (e.g., processor 848A-1), IMUs, tracking emitters or detectors, or sensors). In some embodiments, the HMD 812 includes output audio transducers (e.g., an audio transducer 818), as shown in FIG. 8B-2. In some embodiments, one or more components, such as the output audio transducer(s) 818 and the frame 816, can be configured to attach and detach (e.g., are detachably attachable) to the HMD 812 (e.g., a portion or all of the frame 816 and/or the output audio transducer 818), as shown in FIG. 8B-2. In some embodiments, coupling a detachable component to the HMD 812 causes the detachable component to come into electronic communication with the HMD 812. The VR device 810 includes electronic components, many of which will be described in more detail below with respect to FIG. 8C.

FIGS. 8B-1 and 8B-2 also show that the VR device 810 having one or more cameras, such as the left camera 839A and the right camera 839B, which can be analogous to the left and right cameras on the frame 804 of the AR device 800. In some embodiments, the VR device 810 includes one or more additional cameras (e.g., cameras 839C and 839D), which can be configured to augment image data obtained by the cameras 839A and 839B by providing more information. For example, the camera 839C can be used to supply color information that is not discerned by cameras 839A and 839B. In some embodiments, one or more of the cameras 839A to 839D can include an optional IR (infrared) cut filter configured to remove IR light from being received at the respective camera sensors.

The VR device 810 can include a housing 890 storing one or more components of the VR device 810 and/or additional components of the VR device 810. The housing 890 can be a modular electronic device configured to couple with the VR device 810 (or an AR device 800) and supplement and/or extend the capabilities of the VR device 810 (or an AR device 800). For example, the housing 890 can include additional sensors, cameras, power sources, and processors (e.g., processor 848A-2) to improve and/or increase the functionality of the VR device 810. Examples of the different components included in the housing 890 are described below in reference to FIG. 8C.

Alternatively, or in addition, in some embodiments, the head-wearable device, such as the VR device 810 and/or the AR device 800, includes, or is communicatively coupled to, another external device (e.g., a paired device), such as an HIPD 900 (discussed below in reference to FIGS. 9A-9B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD 900, an optional neckband, and/or a wearable accessory device) with the head-wearable devices (e.g., an AR device 800 and/or a VR device 810) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 900) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 900, can process information generated by one or more of its sensors and/or information provided by other communicatively coupled devices. For example, a head-wearable device can include an IMU, and the intermediary processing device (a neckband and/or an HIPD 900) can compute all inertial and spatial calculations from the IMUs located on the head-wearable device. Additional examples of processing performed by a communicatively coupled device, such as the HIPD 900, are provided below in reference to FIGS. 9A and 9B.

AR systems may include a variety of types of visual feedback mechanisms. For example, display devices in the AR devices 800 and/or the VR devices 810 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 800 and/or the VR device 810 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 800 and the VR device 810, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 800 and/or the VR device 810 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 700, an HIPD 900, or smart textile-based garments), and/or other devices described herein.

FIG. 8C illustrates a computing system 820 and an optional housing 890, each of which shows components that can be included in a head-wearable device (e.g., the AR device 800 and/or the VR device 810). In some embodiments, more or fewer components can be included in the optional housing 890 depending on practical restraints of the respective head-wearable device being described. Additionally or alternatively, the optional housing 890 can include additional components to expand and/or augment the functionality of a head-wearable device.

In some embodiments, the computing system 820 and/or the optional housing 890 can include one or more peripheral interfaces 822A and 822B, one or more power systems 842A and 842B (including charger input 843, PMIC 844, and battery 845), one or more controllers 846A and 846B (including one or more haptic controllers 847), one or more processors 848A and 848B (as defined above, including any of the examples provided), and memory 850A and 850B, which can all be in electronic communication with each other. For example, the one or more processors 848A and/or 848B can be configured to execute instructions stored in the memory 850A and/or 850B, which can cause a controller of the one or more controllers 846A and/or 846B to cause operations to be performed at one or more peripheral devices of the peripherals interfaces 822A and/or 822B. In some embodiments, each operation described can occur based on electrical power provided by the power system 842A and/or 842B.

In some embodiments, the peripherals interface 822A can include one or more devices configured to be part of the computing system 820, many of which have been defined above and/or described with respect to wrist-wearable devices shown in FIGS. 7A and 7B. For example, the peripherals interface can include one or more sensors 823A. Some example sensors include one or more coupling sensors 824, one or more acoustic sensors 825, one or more imaging sensors 826, one or more EMG sensors 827, one or more capacitive sensors 828, and/or one or more IMUs 829. In some embodiments, the sensors 823A further include depth sensors 867, light sensors 868, and/or any other types of sensors defined above or described with respect to any other embodiments discussed herein.

In some embodiments, the peripherals interface can include one or more additional peripheral devices, including one or more NFC devices 830, one or more GPS devices 831, one or more LTE devices 832, one or more Wi-Fi and/or Bluetooth devices 833, one or more buttons 834 (e.g., including buttons that are slidable or otherwise adjustable), one or more displays 835A, one or more speakers 836A, one or more microphones 837A, one or more cameras 838A (e.g., including the first camera 839-1 through nth camera 839-n, which are analogous to the left camera 839A and/or the right camera 839B), one or more haptic devices 840, and/or any other types of peripheral devices defined above or described with respect to any other embodiments discussed herein.

The head-wearable devices can include a variety of types of visual feedback mechanisms (e.g., presentation devices). For example, display devices in the AR device 800 and/or the VR device 810 can include one or more LCDs, LED displays, OLED displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 835A can be coupled to each of the lenses 806-1 and 806-2 of the AR device 800. The displays 835A coupled to each of the lenses 806-1 and 806-2 can act together or independently to present an image or series of images to a user. In some embodiments, the AR device 800 and/or the VR device 810 includes a single display 835A (e.g., a near-eye display) or more than two displays 835A.

In some embodiments, a first set of one or more displays 835A can be used to present an augmented-reality environment, and a second set of one or more display devices 835A can be used to present a VR environment. In some embodiments, one or more waveguides are used in conjunction with presenting AR content to the user of the AR device 800 and/or the VR device 810 (e.g., as a means of delivering light from a display projector assembly and/or one or more displays 835A to the user's eyes). In some embodiments, one or more waveguides are fully or partially integrated into the AR device 800 and/or the VR device 810. Additionally or alternatively, to display screens, some AR systems include one or more projection systems. For example, display devices in the AR device 800 and/or the VR device 810 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 835A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 835A for presenting information to users. For example, an external display 835A can be used to show a current battery level, network activity (e.g., connected, disconnected), current activity (e.g., playing a game, in a call, in a meeting, or watching a movie), and/or other relevant information. In some embodiments, the external displays 835A can be used to communicate with others. For example, a user of the head-wearable device can cause the external displays 835A to present a “do not disturb” notification. The external displays 835A can also be used by the user to share any information captured by the one or more components of the peripherals interface 822A and/or generated by the head-wearable device (e.g., during operation and/or performance of one or more applications).

The memory 850A can include instructions and/or data executable by one or more processors 848A (and/or processors 848B of the housing 890) and/or a memory controller of the one or more controllers 846A (and/or controller 846B of the housing 890). The memory 850A can include one or more operating systems 851, one or more applications 852, one or more communication interface modules 853A, one or more graphics modules 854A, one or more AR processing modules 855A, and/or any other types of modules or components defined above or described with respect to any other embodiments discussed herein.

The data 860 stored in memory 850A can be used in conjunction with one or more of the applications and/or programs discussed above. The data 860 can include profile data 861, sensor data 862, media content data 863, AR application data 864, and/or any other types of data defined above or described with respect to any other embodiments discussed herein.

In some embodiments, the controller 846A of the head-wearable devices processes information generated by the sensors 823A on the head-wearable devices and/or another component of the head-wearable devices and/or communicatively coupled with the head-wearable devices (e.g., components of the housing 890, such as components of peripherals interface 822B). For example, the controller 846A can process information from the acoustic sensors 825 and/or image sensors 826. For each detected sound, the controller 846A can perform a direction of arrival (DOA) estimation to estimate a direction from which the detected sound arrived at a head-wearable device. As one or more of the acoustic sensors 825 detect sounds, the controller 846A can populate an audio data set with the information (e.g., represented by sensor data 862).

In some embodiments, a physical electronic connector can convey information between the head-wearable devices and another electronic device, and/or between one or more processors 848A of the head-wearable devices and the controller 846A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 900) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 800 and/or the VR device 810 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 8B-1 and 8B-2 show the VR device 810 having cameras 839A-839D, which can be used to provide depth information for creating a voxel field and a 2D mesh to provide object information to the user to avoid collisions.

The optional housing 890 can include analogous components to those describe above with respect to the computing system 820. For example, the optional housing 890 can include a respective peripherals interface 822B, including more or fewer components to those described above with respect to the peripherals interface 822A. As described above, the components of the optional housing 890 can be used to augment and/or expand on the functionality of the head-wearable devices. For example, the optional housing 890 can include respective sensors 823B, speakers 836B, displays 835B, microphones 837B, cameras 838B, and/or other components to capture and/or present data. Similarly, the optional housing 890 can include one or more processors 848B, controllers 846B, and/or memory 850B (including respective communication interface modules 853B, one or more graphics modules 854B, one or more AR processing modules 855B) that can be used individually and/or in conjunction with the components of the computing system 820.

The techniques described above in FIGS. 8A-8C can be used with different head-wearable devices. In some embodiments, the head-wearable devices (e.g., the AR device 800 and/or the VR device 810) can be used in conjunction with one or more wearable devices such as a wrist-wearable device 700 (or components thereof). Having thus described example the head-wearable devices, attention will now be turned to example handheld intermediary processing devices, such as HIPD 900.

### Example Handheld Intermediary Processing Devices

FIGS. 9A and 9B illustrate an example handheld intermediary processing device (HIPD) 900, in accordance with some embodiments. The HIPD 900 can perform various functions and/or operations associated with navigating through user interfaces and selectively opening applications.

FIG. 9A shows a top view 905 and a side view 925 of the HIPD 900. The HIPD 900 is configured to communicatively couple with one or more wearable devices (or other electronic devices) associated with a user. For example, the HIPD 900 is configured to communicatively couple with a user's wrist-wearable device 700 (or components thereof, such as the watch body 720 and the wearable band 710), AR device 800, and/or VR device 810. The HIPD 900 can be configured to be held by a user (e.g., as a handheld controller), carried on the user's person (e.g., in their pocket or in their bag), placed in proximity of the user (e.g., placed on their desk while seated at their desk or on a charging dock), and/or placed at or within a predetermined distance from a wearable device or other electronic device (e.g., where, in some embodiments, the predetermined distance is the maximum distance (e.g., 10 meters) at which the HIPD 900 can successfully be communicatively coupled with an electronic device, such as a wearable device).

The HIPD 900 can perform various functions independently and/or in conjunction with one or more wearable devices (e.g., wrist-wearable device 700, AR device 800, and/or VR device 810). The HIPD 900 is configured to increase and/or improve the functionality of communicatively coupled devices, such as the wearable devices. The HIPD 900 is configured to perform one or more functions or operations associated with interacting with user interfaces and applications of communicatively coupled devices, interacting with an AR environment, interacting with a VR environment, and/or operating as a human-machine interface controller, as well as functions and/or operations. Additionally, as will be described in more detail below, functionality and/or operations of the HIPD 900 can include, without limitation, task offloading and/or handoffs, thermals offloading and/or handoffs, 6 degrees of freedom (6DoF) raycasting and/or gaming (e.g., using imaging devices or cameras 914A and 914B, which can be used for simultaneous localization and mapping (SLAM), and/or with other image processing techniques), portable charging, messaging, image capturing via one or more imaging devices or cameras (e.g., cameras 922A and 922B), sensing user input (e.g., sensing a touch on a multitouch input surface 902), wireless communications and/or interlining (e.g., cellular, near field, Wi-Fi, or personal area network), location determination, financial transactions, providing haptic feedback, alarms, notifications, biometric authentication, health monitoring, sleep monitoring. The above-example functions can be executed independently in the HIPD 900 and/or in communication between the HIPD 900 and another wearable device described herein. In some embodiments, functions can be executed on the HIPD 900 in conjunction with an AR environment. As the skilled artisan will appreciate upon reading the descriptions provided herein, the novel HIPD 900 described herein can be used with any type of suitable AR environment.

While the HIPD 900 is communicatively coupled with a wearable device and/or other electronic device, the HIPD 900 is configured to perform one or more operations initiated at the wearable device and/or the other electronic device. In particular, one or more operations of the wearable device and/or the other electronic device can be offloaded to the HIPD 900 to be performed. The HIPD 900 performs one or more operations of the wearable device and/or the other electronic device and provides data corresponding to the completed operations to the wearable device and/or the other electronic device. For example, a user can initiate a video stream using the AR device 800 and back-end tasks associated with performing the video stream (e.g., video rendering) can be offloaded to the HIPD 900, which the HIPD 900 performs and provides corresponding data to the AR device 800 to perform remaining front-end tasks associated with the video stream (e.g., presenting the rendered video data via a display of the AR device 800). In this way, the HIPD 900, which has more computational resources and greater thermal headroom than a wearable device, can perform computationally intensive tasks for the wearable device, improving performance of an operation performed by the wearable device.

The HIPD 900 includes a multi-touch input surface 902 on a first side (e.g., a front surface) that is configured to detect one or more user inputs. In particular, the multi-touch input surface 902 can detect single-tap inputs, multi-tap inputs, swipe gestures and/or inputs, force-based and/or pressure-based touch inputs, held taps, and the like. The multi-touch input surface 902 is configured to detect capacitive touch inputs and/or force (and/or pressure) touch inputs. The multi-touch input surface 902 includes a first touch-input surface 904 defined by a surface depression, and a second touch-input surface 906 defined by a substantially planar portion. The first touch-input surface 904 can be disposed adjacent to the second touch-input surface 906. In some embodiments, the first touch-input surface 904 and the second touch-input surface 906 can be different dimensions, shapes, and/or cover different portions of the multi-touch input surface 902. For example, the first touch-input surface 904 can be substantially circular and the second touch-input surface 906 is substantially rectangular. In some embodiments, the surface depression of the multi-touch input surface 902 is configured to guide user handling of the HIPD 900. In particular, the surface depression is configured such that the user holds the HIPD 900 upright when held in a single hand (e.g., such that the imaging devices or cameras 914A and 914B are pointed toward a ceiling or the sky). Additionally, the surface depression is configured such that the user's thumb rests within the first touch-input surface 904.

In some embodiments, the different touch-input surfaces include a plurality of touch-input zones. For example, the second touch-input surface 906 includes at least a first touch-input zone 908 within a second touch-input zone 906 and a third touch-input zone 910 within the first touch-input zone 908. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 908 causes the HIPD 900 to perform a first command and a user input detected within the second touch-input zone 906 causes the HIPD 900 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 908 can be configured to detect force touch inputs (e.g., a magnitude at which the user presses down) and capacitive touch inputs, and the second touch-input zone 906 can be configured to detect capacitive touch inputs.

The HIPD 900 includes one or more sensors 951 for sensing data used in the performance of one or more operations and/or functions. For example, the HIPD 900 can include an IMU that is used in conjunction with cameras 914 for 3-dimensional object manipulation (e.g., enlarging, moving, or destroying, etc., an object) in an AR or VR environment. Non-limiting examples of the sensors 951 included in the HIPD 900 include a light sensor, a magnetometer, a depth sensor, a pressure sensor, and a force sensor. Additional examples of the sensors 951 are provided below in reference to FIG. 9B.

The HIPD 900 can include one or more light indicators 912 to provide one or more notifications to the user. In some embodiments, the light indicators are LEDs or other types of illumination devices. The light indicators 912 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 904. The light indicators can be illuminated in different colors and/or patterns to provide the user with one or more notifications and/or information about the device. For example, a light indicator positioned around the first touch-input surface 904 can flash when the user receives a notification (e.g., a message), change to red when the HIPD 900 is out of power, operate as a progress bar (e.g., a light ring that is closed when a task is completed (e.g., 0% to 100%)), operate as a volume indicator, etc.

In some embodiments, the HIPD 900 includes one or more additional sensors on another surface. For example, as shown FIG. 9A, HIPD 900 includes a set of one or more sensors (e.g., sensor set 920) on an edge of the HIPD 900. The sensor set 920, when positioned on an edge of the of the HIPD 900, can be prepositioned at a predetermined tilt angle (e.g., 26 degrees), which allows the sensor set 920 to be angled toward the user when placed on a desk or other flat surface. Alternatively, in some embodiments, the sensor set 920 is positioned on a surface opposite the multi-touch input surface 902 (e.g., a back surface). The one or more sensors of the sensor set 920 are discussed in detail below.

The side view 925 of the of the HIPD 900 shows the sensor set 920 and camera 914B. The sensor set 920 includes one or more cameras 922A and 922B, a depth projector 924, an ambient light sensor 928, and a depth receiver 930. In some embodiments, the sensor set 920 includes a light indicator 926. The light indicator 926 can operate as a privacy indicator to let the user and/or those around them know that a camera and/or microphone is active. The sensor set 920 is configured to capture a user's facial expression such that the user can puppet a custom avatar (e.g., showing emotions, such as smiles, laughter, etc., on the avatar or a digital representation of the user). The sensor set 920 can be configured as a side stereo red-green-blue (RGB) system, a rear indirect time-of-flight (iToF) system, or a rear stereo RGB system. As the skilled artisan will appreciate upon reading the descriptions provided herein, the novel HIPD 900 described herein can use different sensor set 920 configurations and/or sensor set 920 placement.

In some embodiments, the HIPD 900 includes one or more haptic devices 971 (FIG. 9B; e.g., a vibratory haptic actuator) that are configured to provide haptic feedback (e.g., kinesthetic sensation). The sensors 951, and/or the haptic devices 971 can be configured to operate in conjunction with multiple applications and/or communicatively coupled devices including, without limitation, a wearable devices, health monitoring applications, social media applications, game applications, and artificial-reality applications (e.g., the applications associated with artificial reality).

The HIPD 900 is configured to operate without a display. However, in optional embodiments, the HIPD 900 can include a display 968 (FIG. 9B). The HIPD 900 can also income one or more optional peripheral buttons 967 (FIG. 9B). For example, the peripheral buttons 967 can be used to turn on or turn off the HIPD 900. Further, the HIPD 900 housing can be formed of polymers and/or elastomer elastomers. The HIPD 900 can be configured to have a non-slip surface to allow the HIPD 900 to be placed on a surface without requiring a user to watch over the HIPD 900. In other words, the HIPD 900 is designed such that it would not easily slide off a surfaces. In some embodiments, the HIPD 900 include one or magnets to couple the HIPD 900 to another surface. This allows the user to mount the HIPD 900 to different surfaces and provide the user with greater flexibility in use of the HIPD 900.

As described above, the HIPD 900 can distribute and/or provide instructions for performing the one or more tasks at the HIPD 900 and/or a communicatively coupled device. For example, the HIPD 900 can identify one or more back-end tasks to be performed by the HIPD 900 and one or more front-end tasks to be performed by a communicatively coupled device. While the HIPD 900 is configured to offload and/or handoff tasks of a communicatively coupled device, the HIPD 900 can perform both back-end and front-end tasks (e.g., via one or more processors, such as CPU 977; FIG. 9B). The HIPD 900 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 900 can perform the above operations alone or in conjunction with a wearable device (or other communicatively coupled electronic device).

FIG. 9B shows block diagrams of a computing system 940 of the HIPD 900, in accordance with some embodiments. The HIPD 900, described in detail above, can include one or more components shown in HIPD computing system 940. The HIPD 900 will be understood to include the components shown and described below for the HIPD computing system 940. In some embodiments, all or a substantial portion of the components of the HIPD computing system 940 are included in a single integrated circuit. Alternatively, in some embodiments, components of the HIPD computing system 940 are included in a plurality of integrated circuits that are communicatively coupled.

The HIPD computing system 940 can include a processor (e.g., a CPU 977, a GPU, and/or a CPU with integrated graphics), a controller 975, a peripherals interface 950 that includes one or more sensors 951 and other peripheral devices, a power source (e.g., a power system 995), and memory (e.g., a memory 978) that includes an operating system (e.g., an operating system 979), data (e.g., data 988), one or more applications (e.g., applications 980), and one or more modules (e.g., a communications interface module 981, a graphics module 982, a task and processing management module 983, an interoperability module 984, an AR processing module 985, a data management module 986, etc.). The HIPD computing system 940 further includes a power system 995 that includes a charger input and output 996, a PMIC 997, and a battery 998, all of which are defined above.

In some embodiments, the peripherals interface 950 can include one or more sensors 951. The sensors 951 can include analogous sensors to those described above in reference to FIG. 7B. For example, the sensors 951 can include imaging sensors 954, (optional) EMG sensors 956, IMUs 958, and capacitive sensors 960. In some embodiments, the sensors 951 can include one or more pressure sensor 952 for sensing pressure data, an altimeter 953 for sensing an altitude of the HIPD 900, a magnetometer 955 for sensing a magnetic field, a depth sensor 957 (or a time-of-flight sensor) for determining a difference between the camera and the subject of an image, a position sensor 959 (e.g., a flexible position sensor) for sensing a relative displacement or position change of a portion of the HIPD 900, a force sensor 961 for sensing a force applied to a portion of the HIPD 900, and a light sensor 962 (e.g., an ambient light sensor) for detecting an amount of lighting. The sensors 951 can include one or more sensors not shown in FIG. 9B.

Analogous to the peripherals described above in reference to FIGS. 7B, the peripherals interface 950 can also include an NFC component 963, a GPS component 964, an LTE component 965, a Wi-Fi and/or Bluetooth communication component 966, a speaker 969, a haptic device 971, and a microphone 973. As described above in reference to FIG. 9A, the HIPD 900 can optionally include a display 968 and/or one or more buttons 967. The peripherals interface 950 can further include one or more cameras 970, touch surfaces 972, and/or one or more light emitters 974. The multi-touch input surface 902 described above in reference to FIG. 9A is an example of touch surface 972. The light emitters 974 can be one or more LEDs, lasers, etc., and can be used to project or present information to a user. For example, the light emitters 974 can include light indicators 912 and 926 described above in reference to FIG. 9A. The cameras 970 (e.g., cameras 914A, 914B, and 922 described above in FIG. 9A) can include one or more wide angle cameras, fish-eye cameras, spherical cameras, compound eye cameras (e.g., stereo- and multi-cameras), depth cameras, RGB cameras, ToF cameras, RGB-D cameras (depth and ToF cameras), and/or other available cameras. Cameras 970 can be used for SLAM; 6 DoF ray casting, gaming, object manipulation, and/or other rendering; facial recognition and facial expression recognition, etc.

Similar to the watch body computing system 760 and the watch band computing system 730 described above in reference to FIG. 7B, the HIPD computing system 940 can include one or more haptic controllers 976 and associated componentry (e.g., haptic devices 971) for providing haptic events at the HIPD 900.

Memory 978 can include high-speed random-access memory and/or non-volatile memory, such as one or more magnetic disk storage devices, flash memory devices, or other non-volatile solid-state memory devices. Access to the memory 978 by other components of the HIPD 900, such as the one or more processors and the peripherals interface 950, can be controlled by a memory controller of the controllers 975.

In some embodiments, software components stored in the memory 978 include one or more operating systems 979, one or more applications 980, one or more communication interface modules 981, one or more graphics modules 982, one or more data management modules 985, which are analogous to the software components described above in reference to FIG. 7B.

In some embodiments, software components stored in the memory 978 include a task and processing management module 983 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 983 uses data 988 (e.g., device data 990) to distribute the one or more front-end and/or back-end tasks based on communicatively coupled devices' computing resources, available power, thermal headroom, ongoing operations, and/or other factors. For example, the task and processing management module 983 can cause the performance of one or more back-end tasks (of an operation performed at communicatively coupled AR device 800) at the HIPD 900 in accordance with a determination that the operation is utilizing a predetermined amount (e.g., at least 70%) of computing resources available at the AR device 800.

In some embodiments, software components stored in the memory 978 include an interoperability module 984 for exchanging and utilizing information received and/or provided to distinct communicatively coupled devices. The interoperability module 984 allows for different systems, devices, and/or applications to connect and communicate in a coordinated way without user input. In some embodiments, software components stored in the memory 978 include an AR module 985 that is configured to process signals based at least on sensor data for use in an AR and/or VR environment. For example, the AR processing module 985 can be used for 3D object manipulation, gesture recognition, facial and facial expression, recognition, etc.

The memory 978 can also include data 987, including structured data. In some embodiments, the data 987 can include profile data 989, device data 989 (including device data of one or more devices communicatively coupled with the HIPD 900, such as device type, hardware, software, configurations, etc.), sensor data 991, media content data 992, and application data 993.

It should be appreciated that the HIPD computing system 940 is an example of a computing system within the HIPD 900, and that the HIPD 900 can have more or fewer components than shown in the HIPD computing system 940, combine two or more components, and/or have a different configuration and/or arrangement of the components. The various components shown in HIPD computing system 940 are implemented in hardware, software, firmware, or a combination thereof, including one or more signal processing and/or application-specific integrated circuits.

The techniques described above in FIG. 9A-9B can be used with any device used as a human-machine interface controller. In some embodiments, an HIPD 900 can be used in conjunction with one or more wearable device such as a head-wearable device (e.g., AR device 800 and VR device 810) and/or a wrist-wearable device 700 (or components thereof). Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

FIG. 10 illustrates an example method flow chart 1000 for producing an artificial-reality headset, in accordance with some embodiments. A method of producing an artificial-reality headset comprises, providing (step 1002, as shown in FIG. 10) a first lens assembly coupled with a first shape guide; providing (1004) a second lens assembly coupled with a second shape guide. The method includes, coupling (1006) an interpupillary-distance adjustment system with the first lens assembly and the second lens assembly, and the interpupillary-distance adjustment mechanism is configured to move one or both of the first lens assembly and the second lens assembly to produce (i) a first interpupillary distance between the first lens assembly and the second lens assembly and (ii) a second interpupillary distance between the first lens assembly and the second lens assembly. The method also includes, coupling (1008) the polymer-based membrane to the first lens assembly and the second lens assembly (and/or the interpupillary-distance adjustment mechanism), and the polymer-based membrane having: a first opening associated with the first lens assembly, a second opening, distinct from the first opening, associated with the second lens assembly, and portions of the polymer-based membrane surrounding the first opening and the second opening. The polymer-based membrane is in contact (1010) with the first shape guide and the second shape guide such that: when the first interpupillary distance is produced between the first lens assembly and the second lens assembly, a number of creases in the portions of the polymer-based membrane surrounding the first opening and the second opening is a first number, and when the second interpupillary distance is produced between the first lens assembly and the second lens assembly, no new creases are introduced in the portions of the polymer-based membrane surrounding the first opening and the second opening, such that the number of creases is maintained at the first number.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An artificial-reality headset, comprising:
a first lens assembly coupled with a first shape guide;
a second lens assembly coupled with a second shape guide;
an interpupillary-distance adjustment system that is configured to move one or both of the first lens assembly and the second lens assembly to produce (i) a first interpupillary distance between the first lens assembly and the second lens assembly and (ii) a second interpupillary distance between the first lens assembly and the second lens assembly;
a polymer-based membrane having:
a first opening associated with the first lens assembly,
a second opening, distinct from the first opening, associated with the second lens assembly, and
portions of the polymer-based membrane surrounding the first opening and the second opening;
wherein the polymer-based membrane is in contact with the first shape guide and the second shape guide such that:
when the first interpupillary distance is produced between the first lens assembly and the second lens assembly, a number of creases in the portions of the polymer-based membrane surrounding the first opening and the second opening is a first number, and
when the second interpupillary distance is produced between the first lens assembly and the second lens assembly, no new creases are introduced in the portions of the polymer-based membrane surrounding the first opening and the second opening, such that the number of creases is maintained at the first number.

2. The artificial-reality headset of claim 1, wherein:
the first interpupillary distance is greater than the second interpupillary distance; and
the interpupillary-distance adjustment system is configured to move one or both of the first lens assembly and the second lens assembly to produce a third interpupillary distance between the first lens assembly and the second lens assembly, wherein the third interpupillary distance is less than the first interpupillary distance and greater than the second interpupillary distance; and
when the third interpupillary distance is produced between the first lens assembly and the second lens assembly, no new creases are introduced in the portions of the polymer-based membrane surrounding the first opening and the second opening, such that the number of creases is maintained at the first number.

3. The artificial-reality headset of claim 1, wherein:
the first shape guide includes a first elongated portion to maintain contact with the polymer-based membrane and to maintain the first number of creases in the portions of the polymer-based membrane when the first interpupillary distance or the second interpupillary distance is produced, wherein the first elongated portion does not extend around a full perimeter of the first shape guide; and
the second shape guide includes a second elongated portion to maintain contact with the polymer-based membrane and to maintain the first number of creases in the portions of the polymer-based membrane when the first interpupillary distance or the second interpupillary distance is produced, wherein the second elongated portion does not extend around a full perimeter of the second shape guide, and wherein the first elongated portion faces the second elongated portion.

4. The artificial-reality headset of claim 1, wherein:
the first shape guide circumscribes the first lens assembly to couple with the first lens assembly and defines the first opening; and
the second shape guide circumscribes the second lens assembly to couple with the second lens assembly and defines the second opening.

5. The artificial-reality headset of claim 1, wherein the polymer-based membrane is configured to slidably rest on top of first shape guide and the second shape guide to allow movement of one or more predefined creases such that no new creases are introduced.

6. The artificial-reality headset of claim 1, wherein the polymer-based membrane includes predefined creases that have respective depths that are configured to change when a distance between the first lens assembly and the second lens assembly is adjusted via the interpupillary-distance adjustment system, such that no new creases are introduced.

7. The artificial-reality headset of claim 1, wherein the polymer-based membrane spans a length of the artificial-reality headset and the polymer-based membrane varies in thickness across the length of the artificial-reality headset, wherein respective variations in thickness are selected such that no new creases are introduced when a distance between the first lens assembly and the second lens assembly is adjusted via the interpupillary-distance adjustment system.

8. The artificial-reality headset of claim 7, wherein the respective variations in thickness are positioned where a flexible portion of the polymer-based membrane is molded to a portion of the artificial-reality headset.

9. The artificial-reality headset of claim 1, wherein:
the first shape guide is coupled to the first lens assembly at locations around the first lens assembly, the location selected such that forces transmitted from the polymer-based membrane to the first lens assembly are controlled to remove artifacts caused by a misalignment of one or more lenses within the first lens assembly; and
the second shape guide is coupled to the second lens assembly at locations around the first lens assembly, the location selected such that forces transmitted from the polymer-based membrane to the second lens assembly are controlled to remove artifacts caused by a misalignment of one or more lenses within the second lens assembly.

10. The artificial-reality headset of claim 1, wherein the polymer-based membrane is molded with one or more rigid structures, wherein the rigid structures are configured to couple with (i) the first lens assembly, (ii) the second lens assembly, and (iii) a stationary portion of the artificial-reality headset to produce an interpupillary-distance adjustment system cover.

11. The artificial-reality headset of claim 1, wherein the polymer-based membrane is molded with one or more rigid structures via a two-shot injection molding process, wherein a first shot forms the one or more rigid structures and a second shot molds the polymer-based membrane to the one or more rigid structures.

12. The artificial-reality headset of claim 1, wherein no surface treatment is needed on the one or more rigid structured to secure the polymer-based membrane to the one or more rigid structures.

13. The artificial-reality headset of claim 1, wherein a one or more rigid structures are infrared transparent, such that an infrared sensor can receive one or more infrared signals.

14. A shape guide, comprising:
a coupling that is configured to secure the shape guide to a lens assembly, and the lens assembly is configured to be coupled to an interpupillary-distance adjustment system, wherein the interpupillary-distance adjustment system is configured to move the lens assembly to produce (i) a first interpupillary distance between the lens assembly and another lens assembly and (ii) a second interpupillary distance between the lens assembly and the other lens assembly;
another coupling that is configured to secure a polymer-based membrane around a first portion of the shape guide;
a second portion of the shape guide having an elongated surface configured to guide a portion of the polymer-based membrane, such that:
when the first interpupillary distance is produced between the lens assembly and the other lens assembly, a number of creases in the polymer-based membrane is a first number, wherein the first number is partially dictated by the shape guide, and
when the second interpupillary distance is produced between the lens assembly and the other lens assembly, no new creases are introduced in the polymer-based membrane, such that the number of creases is maintained at the first number.

15. The shape guide of claim 14, wherein:
the first interpupillary distance is greater than the second interpupillary distance; and
the interpupillary-distance adjustment system is configured to move one or both of the lens assembly and the other lens assembly to produce a third interpupillary distance between the lens assembly and the other lens assembly, wherein the third interpupillary distance is less than the first interpupillary distance and greater than the second interpupillary distance; and
when the third interpupillary distance is produced between the lens assembly and the other lens assembly, no new creases are introduced in the portions of the polymer-based membrane surrounding a first opening and a second opening, such that the number of creases is maintained at the first number.

16. The shape guide of claim 14, wherein:
the first shape guide circumscribes the lens assembly to couple with the lens assembly and defines a first opening.

17. The shape guide of claim 14, wherein the polymer-based membrane includes predefined creases that have respective depths that are configured to change when a distance between the lens assembly and the other lens assembly is adjusted via the interpupillary-distance adjustment system, such that no new creases are introduced.

18. A polymer-based membrane, comprising:
a first opening associated with a first lens assembly, wherein the first lens assembly is coupled with a first shape guide,
a second opening, distinct from the first opening, associated with a second lens assembly, wherein the second lens assembly is coupled with a second shape guide, and
portions of the polymer-based membrane surrounding the first opening and the second opening
wherein the polymer-based membrane is configured to be coupled with an interpupillary-distance adjustment system, and the interpupillary adjustment system is configured to move one or both of the first lens assembly and the second lens assembly to produce (i) a first interpupillary distance between the first lens assembly and the second lens assembly and (ii) a second interpupillary distance between the first lens assembly and the second lens assembly;
wherein the polymer-based membrane is in contact with the first shape guide and the second shape guide such that:
when the first interpupillary distance is produced between the first lens assembly and the second lens assembly, a number of creases in the portions of the polymer-based membrane surrounding the first opening and the second opening is a first number, and
when the second interpupillary distance is produced between the first lens assembly and the second lens assembly, no new creases are introduced in the portions of the polymer-based membrane surrounding the first opening and the second opening, such that the number of creases is maintained at the first number.

19. The polymer-based membrane of claim 18, wherein:
the first interpupillary distance is greater than the second interpupillary distance; and
the interpupillary-distance adjustment system is configured to move one or both of the first lens assembly and the second lens assembly to produce a third interpupillary distance between the first lens assembly and the second lens assembly, wherein the third interpupillary distance is less than the first interpupillary distance and greater than the second interpupillary distance; and
when the third interpupillary distance is produced between the first lens assembly and the second lens assembly, no new creases are introduced in the portions of the polymer-based membrane surrounding the first opening and the second opening, such that the number of creases is maintained at the first number.

20. The polymer-based membrane of claim 18, wherein:
the first shape guide circumscribes the first lens assembly to couple with the first lens assembly and defines the first opening; and
the second shape guide circumscribes the second lens assembly to couple with the second lens assembly and defines the second opening.
